(19) United States
(12) Patent Application Publication
(10) Pub. No.: US 2018/0270696 A1
(43) Pub. Date: Sep. 20, 2018

(54) Wireless Communications Access Method, Communications Apparatus, Wireless Terminal, and System

(71) Applicant: Huawei Technologies Co., Ltd., Shenzhen (CN)

(72) Inventors: Xiaoyan Duan, Beijing (CN); Hui Jin, Beijing (CN)

(21) Appl. No.: 15/743,442

(22) PCT Filed: Aug. 20, 2015
(86) PCT No.: PCT/CN2015/087580

§ 371 Date: Jan. 10, 2018

(51) Int. Cl. H04W 28/02; H04W 28/24; H04W 48/16; H04W 48/02

(52) U.S. Cl. CPC H04W 28/0268; H04W 28/24; H04W 28/0215; H04W 48/02; H04W 48/16

(57) ABSTRACT

Embodiments of the disclosure provide a wireless communications access method, a communications apparatus, a wireless terminal, and a system, and includes receiving, by a core network device, a first connection request sent by a first access node, where the first connection request carries a device type and/or a service type of a wireless terminal, determining, by the core network device according to the device type and/or the service type of the wireless terminal and a device capability of an access node that can be accessed by the wireless terminal, an access node whose device capability can support the device type and/or the service type of the wireless terminal as a target access node, and instructing, by the core network device, the wireless terminal to access a network by using the target access node.

### CROSS-REFERENCE TO RELATED APPLICATIONS

This application is a national stage application of International Patent Application No. PCT/CN2015/087580, filed on Aug. 20, 2015, which is hereby incorporated by reference in its entirety.

### TECHNICAL FIELD

Embodiments of the disclosure relate to communications technologies, and in particular, to a wireless communications access method, a communications apparatus, a wireless terminal, and a system.

### BACKGROUND

With continuous development of mobile communications technologies, the 5th generation wireless communications system (5G) is to support access by multiple types of terminal devices, including an inter-personal communications device (such as a smartphone), a machine type device, an automobile, an unmanned aerial vehicle, a robot, and the like. Different terminals have different requirements on service types. A same terminal has different requirements on service types in different scenarios. For example, a smartphone initiates a voice/video call and data service in an entertainment environment, and initiates a navigation and automatic drive control service in an automotive environment. Different device types or service types have different requirements on quality of service (QoS) of communication services in a mobile communications network. For example, the voice/video call and data service requires QoS of a high rate and a relatively low latency. The navigation and automatic drive control service requires QoS of a relatively high rate and an ultra-low latency.

In addition, the 5G system is to further support multiple types of access networks, for example, a 3rd Generation Partnership Project (3GPP) network, and a non-3rd Generation Partnership Project (such as Bluetooth or WLAN) network. There are multiple types of access nodes, for example, a base station, a terminal that supports device-to-device (D2D) communication, and a wireless access point (AP), in an access network. Different access nodes in an access network support different communication types, such as ultra-broadband wireless communication (or referred to as enhance mobile broadband enhanced mobile broadband communication), and machine type communication (MTC). Therefore, different types of access networks provide different QoS, and different access nodes in a same access network also provide different QoS.

In an existing wireless communications system, a terminal selects according to a network signal status, such as signal power or signal quality, a serving cell for network access. However, the serving cell selected by the terminal may not support a particular communication type, and therefore, cannot meet a service requirement of the terminal.

### SUMMARY

Embodiments of the disclosure provide a wireless communications access method, a communications apparatus, a wireless terminal, and a system, so that terminals of different device types or service types access nodes meeting their service requirements, and better communication quality is provided for wireless terminals.

According to a first aspect, an embodiment of the disclosure provides a wireless communications access method, where the method includes receiving, by a core network device, a first connection request sent by a first access node, where the first connection request carries a device type and/or a service type of a wireless terminal determining, by the core network device according to the device type and/or the service type of the wireless terminal and a device capability of an access node that can be accessed by the wireless terminal, an access node whose device capability can support the device type and/or the service type of the wireless terminal as a target access node; and instructing, by the core network device, the wireless terminal to access a network by using the target access node.

In a first possible implementation of the first aspect, the first connection request further carries a device capability of the first access node.

With reference to the first aspect or the first possible implementation of the first aspect, in a second possible implementation, the determining, by the core network device according to the device type and/or the service type of the wireless terminal and a device capability of an access node that can be accessed by the wireless terminal, an access node whose device capability can support the device type and/or the service type of the wireless terminal as a target access node includes determining, by the core network device according to the device type and/or the service type of the wireless terminal and the device capability of the first access node, whether the device capability of the first access node supports the device type and/or the service type of the wireless terminal; and using, by the core network device, the first access node as the target access node if the device capability of the first access node supports the device type and/or the service type of the wireless terminal.

With reference to the first aspect or the first possible implementation of the first aspect, in a third possible implementation, the determining, by the core network device according to the device type and/or the service type of the wireless terminal and a device capability of an access node that can be accessed by the wireless terminal, an access node whose device capability can support the device type and/or the service type of the wireless terminal as a target access node includes determining, by the core network device according to the device type and/or the service type of the wireless terminal and the device capability of the first access node, whether the device capability of the first access node supports the device type and/or the service type of the wireless terminal, and if the device capability of the first access node does not support the device type and/or the service type of the wireless terminal, determining, by the core network device according to the device type and/or the service type of the wireless terminal and a device capability of the second access node, whether the device capability of the second access node supports the device type and/or the service type of the wireless terminal, where the second access node is an access node that can be accessed by the wireless terminal other than the first access node, and using, by the core network device, the second access node as the target access node if the device capability of the second access node supports the device type and/or the service type of the wireless terminal.

With reference to any one of the first aspect or the first to the third possible implementations of the first aspect, in a fourth possible implementation, the first connection request further carries location information of the wireless terminal, and after the receiving, by a core network device, a first connection request sent by a first access node, the method further includes determining, by the core network device according to the location information of the wireless terminal, the access node that can be accessed by the wireless terminal, and obtaining, by the core network device, the device capability of the access node that can be accessed by the wireless terminal.

With reference to any one of the first aspect or the first to the fourth possible implementations of the first aspect, in a fifth possible implementation, after the determining, by the core network device according to the device type and/or the service type of the wireless terminal and a device capability of an access node that can be accessed by the wireless terminal, an access node whose device capability can support the device type and/or the service type of the wireless terminal as a target access node, the method further includes if there is no access node whose device capability supports the device type and/or the service type of the wireless terminal, matching, by the core network device, quality of service that is required by the device type and/or the service type of the wireless terminal with quality of service that is provided by the access node that can be accessed by the wireless terminal, determining an access node having a highest quality of service matching degree as a secondary target access node, and instructing, by the core network device, the wireless terminal to access the network by using the secondary target access node.

With reference to any one of the first aspect or the first possible implementation or the third to the fifth possible implementations of the first aspect, in a sixth possible implementation, if the target access node is the second access node that can be accessed by the wireless terminal other than the first access node, the instructing, by the core network device, the wireless terminal to access a network by using the target access node includes sending, by the core network device, a first connection response in response to the first connection request to the first access node, where the first connection response carries redirection information for instructing the wireless terminal to connect to the second access node, receiving, by the core network device, a second connection request sent by the second access node, where the second connection request is a connection request that is sent when the wireless terminal connects to the second access node according to the redirection information, and sending, by the core network device, a second connection response in response to the second connection request to the second access node according to the second connection request.

With reference to the sixth possible implementation of the first aspect, in a seventh possible implementation, the second connection request carries indication information indicating that the second connection request and the first connection request belong to a same connection transaction.

With reference to any one of the first aspect or the first possible implementation or the third to the fifth possible implementations of the first aspect, in an eighth possible implementation, if the target access node is the second access node that can be accessed by the wireless terminal other than the first access node, the instructing, by the core network device, the wireless terminal to access a network by using the target access node includes sending, by the core network device, a handover request to the second access node, where the handover request carries configuration information for establishing a radio access bearer for the wireless terminal, so that the second access node establishes a radio access bearer for the wireless terminal according to the radio access bearer configuration information, receiving, by the core network device, a handover response sent by the second access node, where the handover response carries radio resource configuration information of the radio access bearer, so that the wireless terminal establishes a radio bearer between the wireless terminal and the second access node according to the radio resource configuration information, and sending, by the core network device, a third connection response in response to the first connection request to the first access node according to the handover response, where the third connection response carries the radio resource configuration information and a handover indication for instructing the wireless terminal to switch to the second access node.

With reference to any one of the first aspect or the first possible implementation or the third to the fifth possible implementations of the first aspect, in a ninth possible implementation, if the target access node is the second access node that can be accessed by the wireless terminal other than the first access node, the instructing, by the core network device, the wireless terminal to access a network by using the target access node includes sending, by the core network device, a fourth connection response in response to the first connection request to the second access node, where the fourth connection response carries configuration information for establishing a radio access bearer for the wireless terminal and an identifier of the wireless terminal.

With reference to any one of the first aspect or the first to the ninth possible implementations of the first aspect, in a tenth possible implementation, the device capability further includes a session management capability supported by the access node.

According to a second aspect, an embodiment of the disclosure provides a wireless communications access method, where the method includes receiving, by an access node, a fourth connection response sent by a core network device, where the fourth connection response carries configuration information for establishing a radio access bearer for a wireless terminal and an identifier of the wireless terminal, establishing, by the access node, a wireless connection to the wireless terminal according to the identifier of the wireless terminal, and establishing a radio access bearer for the wireless terminal according to the radio access bearer configuration information, and sending, by the access node, a fifth connection response to the wireless terminal, where the fifth connection response carries radio resource configuration information of the radio access bearer, so that the wireless terminal establishes, between the wireless terminal and the access node according to the radio resource configuration information of the radio access bearer, a radio bearer used for data transmission.

In a first possible implementation of the second aspect, the fourth connection response further carries a first indication indicating that the wireless terminal is redirected to the access node.

According to a third aspect, an embodiment of the disclosure provides a wireless communications access method, where the method includes sending, by a wireless terminal, a first registration request to a first access node, where the first registration request carries a device type and/or a service type of the wireless terminal, receiving, by the wireless terminal, a first registration response that is sent by the first access node and that is in response to the first registration request, where the first registration response carries registration redirection information for instructing the wireless terminal to connect to a second access node whose device capability can support the device type and/or the service type of the wireless terminal, for registration, sending, by the wireless terminal, a second registration request to the second access node according to the registration redirection information; and receiving, by the wireless terminal, a second registration response that is sent by the second access node and that is in response to the second registration request, and completing a registration process according to the second registration response.

In a first possible implementation of the third aspect, the second registration request carries a transaction identifier indicating that the second registration request and the first registration request belong to a same registration transaction.

In a second possible implementation of the third aspect, the second registration response carries radio resource configuration information of a radio access bearer that is established for the wireless terminal by the second access node, and the receiving, by the wireless terminal, a second registration response that is sent by the second access node and that is in response to the second registration request, and completing a registration process includes establishing, by the wireless terminal between the wireless terminal and the second access node according to the radio resource configuration information of the radio access bearer in the second registration response, a radio bearer used for data transmission, and completing a registration process.

According to a fourth aspect, an embodiment of the disclosure provides a wireless communications access method, where the method includes sending, by a wireless terminal, a first registration request to a first access node, where the first registration request carries a device type and/or a service type of the wireless terminal, receiving, by the wireless terminal, a third registration response that is sent by the first access node and that is in response to the first registration request, where the third registration response carries a registration handover indication for instructing the wireless terminal to switch to a second access node whose device capability can support the device type and/or the service type of the wireless terminal, and radio resource configuration information of a radio access bearer established for the wireless terminal by the second access node, and establishing, by the wireless terminal between the wireless terminal and the second access node according to the registration handover indication and the radio resource configuration information of the radio access bearer, a radio bearer used for data transmission, and completing a registration process.

With reference to any possible implementation of the third aspect or the fourth aspect, in another possible implementation, the method further includes sending, by the wireless terminal, a registration information deletion request to the first access node, where the registration information deletion request is used to request the first access node to delete registration information of the wireless terminal.

According to a fifth aspect, an embodiment of the disclosure provides a communications apparatus, where the apparatus includes a first receiving module configured to receive a first connection request sent by a first access node, where the first connection request carries a device type and/or a service type of a wireless terminal; a first processing module configured to determine, according to the device type and/or the service type of the wireless terminal and a device capability of an access node that can be accessed by the wireless terminal, an access node whose device capability can support the device type and/or the service type of the wireless terminal as a target access node; and a first indication module configured to instruct the wireless terminal to access a network by using the target access node.

In a first possible implementation of the fifth aspect, the first connection request further carries a device capability of the first access node.

With reference to the fifth aspect or the first possible implementation of the fifth aspect, in a second possible implementation, the first processing module includes a first judging unit configured to determine, according to the device type and/or the service type of the wireless terminal and the device capability of the first access node, whether the device capability of the first access node supports the device type and/or the service type of the wireless terminal, and a first determining unit configured to use the first access node as the target access node if the device capability of the first access node supports the device type and/or the service type of the wireless terminal.

With reference to the fifth aspect or the first possible implementation of the fifth aspect, in a third possible implementation, the first processing module includes a first judging unit configured to determine, according to the device type and/or the service type of the wireless terminal and the device capability of the first access node, whether the device capability of the first access node supports the device type and/or the service type of the wireless terminal, a second judging unit configured to if the device capability of the first access node does not support the device type and/or the service type of the wireless terminal, determine, according to the device type and/or the service type of the wireless terminal and a device capability of the second access node, whether the device capability of the second access node supports the device type and/or the service type of the wireless terminal, where the second access node is an access node that can be accessed by the wireless terminal other than the first access node; and a second determining unit configured to use the second access node as the target access node if the device capability of the second access node supports the device type and/or the service type of the wireless terminal.

With reference to any one of the fifth aspect or the first to the third possible implementations of the fifth aspect, in a fourth possible implementation, the first connection request further carries location information of the wireless terminal, and the apparatus further includes a query module configured to determine, by the core network device according to the location information of the wireless terminal, the access node that can be accessed by the wireless terminal, and obtain the device capability of the access node that can be accessed by the wireless terminal.

With reference to any one of the fifth aspect or the first to the fourth possible implementations of the fifth aspect, in a fifth possible implementation, the first processing module is further configured to, if there is no access node whose device capability supports the device type and/or the service type of the wireless terminal, match quality of service that is required by the device type and/or the service type of the wireless terminal with quality of service that is provided by the access node that can be accessed by the wireless terminal, and determine an access node having a highest quality of service matching degree as a secondary target access node, and the first indication module is further configured to instruct the wireless terminal to access the network by using the secondary target access node.

With reference to any one of the fifth aspect or the first possible implementation or the third to the fifth possible implementations of the fifth aspect, in a sixth possible implementation, the first indication module includes a first indication sending unit configured to if the target access node is the second access node that can be accessed by the wireless terminal other than the first access node, send a first connection response in response to the first connection request to the first access node, where the first connection response carries redirection information for instructing the wireless terminal to connect to the second access node, a first indication receiving unit configured to receive a second connection request sent by the second access node, where the second connection request is a connection request that is sent when the wireless terminal connects to the second access node according to the redirection information, and a first indication processing unit configured to instruct, according to the second connection request, the first indication sending unit to send, to the second access node, a second connection response used to indicate that the core network device accepts the second connection request.

With reference to the sixth possible implementation of the fifth aspect, in a seventh possible implementation, the second connection request carries indication information indicating that the second connection request and the first connection request belong to a same connection transaction.

With reference to any one of the fifth aspect or the first possible implementation or the third to the fifth possible implementations of the fifth aspect, in an eighth possible implementation, the first indication module includes a second indication sending unit configured to if the target access node is the second access node that can be accessed by the wireless terminal other than the first access node, send a handover request to the second access node, where the handover request carries configuration information for establishing a radio access bearer for the wireless terminal, so that the second access node establishes a radio access bearer for the wireless terminal according to the radio access bearer configuration information; a second indication receiving unit configured to receive a handover response sent by the second access node, where the handover response carries radio resource configuration information of the radio access bearer, so that the wireless terminal establishes a radio bearer between the wireless terminal and the second access node according to the radio resource configuration information, and a second indication processing unit configured to instruct, according to the handover response, the second indication sending unit to send a third connection response in response to the first connection request to the first access node, where the third connection response carries the radio resource configuration information and a handover indication for instructing the wireless terminal to switch to the second access node.

With reference to any one of the fifth aspect or the first possible implementation or the third to the fifth possible implementations of the fifth aspect, in a ninth possible implementation, the first indication module is further configured to, if the target access node is the second access node that can be accessed by the wireless terminal other than the first access node, send a fourth connection response in response to the first connection request to the second access node, where the fourth connection response carries configuration information for establishing a radio access bearer for the wireless terminal and an identifier of the wireless terminal.

With reference to any one of the fifth aspect or the first to the ninth possible implementations of the fifth aspect, in a tenth possible implementation, the device capability further includes a session management capability supported by the access node.

According to a sixth aspect, an embodiment of the disclosure provides a communications apparatus, where the apparatus includes a second receiving module configured to receive a fourth connection response sent by a core network device, where the fourth connection response carries configuration information for establishing a radio access bearer for a wireless terminal and an identifier of the wireless terminal, a bearer establishment module configured to establish a wireless connection to the wireless terminal according to the identifier of the wireless terminal, and establish a radio access bearer for the wireless terminal according to the radio access bearer configuration information; and a second sending module configured to send a fifth connection response to the wireless terminal, where the fifth connection response carries radio resource configuration information of the radio access bearer, so that the wireless terminal establishes, between the wireless terminal and the access node according to the radio resource configuration information of the radio access bearer, a radio bearer used for data transmission.

In a first possible implementation of the sixth aspect, the fourth connection response further carries a first indication indicating that the wireless terminal is redirected to the access node.

According to a seventh aspect, an embodiment of the disclosure provides a wireless terminal, where the wireless terminal includes a first terminal sending module configured to send a first registration request to a first access node, where the first registration request carries a device type and/or a service type of the wireless terminal, a first terminal receiving module configured to receive a first registration response that is sent by the first access node and that is in response to the first registration request, where the first registration response carries registration redirection information for instructing the wireless terminal to connect to a second access node whose device capability can support the device type and/or the service type of the wireless terminal, for registration, a first terminal processing module configured to instruct, according to the registration redirection information, the first terminal sending module to send a second registration request to the second access node, where the first terminal receiving module is further configured to receive a second registration response that is sent by the second access node and that is in response to the second registration request, and a first registration module configured to complete a registration process according to the second registration response.

In a first possible implementation of the seventh aspect, the second registration request carries a transaction identifier indicating that the second registration request and the first registration request belong to a same registration transaction.

In a second possible implementation of the seventh aspect, the second registration response carries radio resource configuration information of a radio access bearer that is established for the wireless terminal by the second access node, and the first registration module is further configured to establish, between the wireless terminal and the second access node according to the radio resource configuration information of the radio access bearer in the second registration response, a radio bearer used for data transmission.

According to an eighth aspect, an embodiment of the disclosure provides a wireless terminal, where the wireless terminal includes a first terminal sending module configured to send a first registration request to a first access node, where the first registration request carries a device type and/or a service type of the wireless terminal, a second terminal receiving module configured to receive a third registration response that is sent by the first access node and that is in response to the first registration request, where the third registration response carries a registration handover indication for instructing the wireless terminal to switch to a second access node whose device capability can support the device type and/or the service type of the wireless terminal, and radio resource configuration information of a radio access bearer established for the wireless terminal by the second access node, and a second registration module configured to establish, between the wireless terminal and the second access node according to the handover indication and the radio resource configuration information of the radio access bearer, a radio bearer used for data transmission, and complete a registration process.

With reference to any possible implementation of the seventh aspect or the eighth aspect, in another possible implementation, the first terminal sending module is further configured to send a registration information deletion request to the first access node, where the registration information deletion request is used to request the first access node to delete registration information of the wireless terminal.

According to a ninth aspect, an embodiment of the disclosure provides a wireless communications access system, where the system includes the communications apparatus in any implementation of the fifth aspect and the communications apparatus in any implementation of the sixth aspect.

According to a tenth aspect, an embodiment of the disclosure provides a communications apparatus, including one or more processors; a memory, and one or more programs, where the one or more programs are stored in the memory and are configured to be executed by the one or more processors, and the one or more programs include an instruction used to perform the method in any implementation of the first aspect.

According to an eleventh aspect, an embodiment of the disclosure provides a communications apparatus, including one or more processors, a memory, and one or more programs, where the one or more programs are stored in the memory and are configured to be executed by the one or more processors, and the one or more programs include an instruction used to perform the method in any implementation of the second aspect.

According to a twelfth aspect, an embodiment of the disclosure provides a wireless terminal, including one or more processors, a memory, and one or more programs, where the one or more programs are stored in the memory and are configured to be executed by the one or more processors, and the one or more programs include an instruction used to perform the method in any implementation of the third aspect or the fourth aspect.

In the embodiments of the disclosure, a core network device determines, according to a device type and/or a service type of a wireless terminal and a device capability of an access node that can be accessed by the wireless terminal, an access node whose device capability can support the device type and/or the service type of the wireless terminal as a target access node, and instructs the wireless terminal to access a network by using the target access node. Terminals of different device types or service types access nodes meeting their service requirements, so that better communication quality is provided for wireless terminals.

### BRIEF DESCRIPTION OF THE DRAWINGS

To describe the technical solutions in the embodiments of the disclosure or in the prior art more clearly, the following briefly describes the accompanying drawings required for describing the embodiments or the prior art. The accompanying drawings in the following description show merely some embodiments of the disclosure, and a person of ordinary skill in the art may still derive other drawings from these accompanying drawings without creative efforts.

FIG. 1 is a schematic flowchart of a wireless communications access method according to Embodiment 1 of the disclosure.

FIG. 2 is a schematic flowchart of another wireless communications access method according to Embodiment 1 of the disclosure.

FIG. 3 is a schematic flowchart of another wireless communications access method according to Embodiment 2 of the disclosure.

FIG. 4 is a schematic flowchart of another wireless communications access method according to Embodiment 2 of the disclosure.

FIG. 5 is a schematic diagram of information exchange between devices in another wireless communications access method according to Embodiment 2 of the disclosure.

FIG. 6 is a schematic flowchart of another wireless communications access method according to Embodiment 3 of the disclosure.

FIG. 7 is a schematic flowchart of another wireless communications access method according to Embodiment 3 of the disclosure.

FIG. 8 is a schematic diagram of information exchange between devices in another wireless communications access method according to Embodiment 3 of the disclosure.

FIG. 9 is a schematic flowchart of another wireless communications access method according to Embodiment 4 of the disclosure.

FIG. 10 is a schematic flowchart of another wireless communications access method according to Embodiment 4 of the disclosure.

FIG. 11 is a schematic diagram of information exchange between devices in another wireless communications access method according to Embodiment 4 of the disclosure.

FIG. 12 is a schematic structural diagram of a communications apparatus according to Embodiment 5 of the disclosure.

FIG. 13 is a schematic structural diagram of another communications apparatus according to Embodiment 5 of the disclosure.

FIG. 14 is a schematic structural diagram of another communications apparatus according to Embodiment 5 of the disclosure.

FIG. 15 is a schematic structural diagram of another communications apparatus according to Embodiment 5 of the disclosure.

FIG. 16 is a schematic structural diagram of another communications apparatus according to Embodiment 5 of the disclosure.

FIG. 17 is a schematic structural diagram of a wireless terminal according to Embodiment 5 of the disclosure.

FIG. 18 is a schematic structural diagram of another wireless terminal according to Embodiment 5 of the disclosure.

### DETAILED DESCRIPTION OF THE EMBODIMENTS

The following describes the technical solutions in the embodiments of the disclosure with reference to the accompanying drawings in the embodiments of the disclosure. The described embodiments are merely some but not all of the embodiments of the disclosure. All other embodiments obtained by a person of ordinary skill in the art based on the embodiments of the disclosure without creative efforts shall fall within the protection scope of the disclosure.

First, wording and terms used in the embodiments are explained below.

When ordinal numbers such as “first” and “second” are mentioned in the embodiments of the disclosure, it should be understood that they are used merely for distinguishing, unless they really express the meaning of a sequence according to context.

The technical solutions provided in the embodiments of the disclosure are applied to a scenario in which a wireless terminal accesses a network by using a changed access node. For example, a wireless terminal initiates a registration request. After receiving the registration request of the wireless terminal that is sent by an access node, a core network device determines, according to a device type and/or a service type of the wireless terminal and a device capability of an access node that can be locally accessed by the wireless terminal, an access node whose device capability can support the device type and/or the service type of the wireless terminal as a target access node. If the determined target access node and an original access node are a same access node, the original access node continues to complete a registration transaction of the wireless terminal. If the determined target node and the original access node are different access nodes, the target access node is instructed to substitute for the original access node to complete the registration transaction of the wireless terminal. That is, the wireless terminal switches from the original access node to the target access node for registration.

In an actual application, the wireless terminal may be multiple types of communications device that can access a wireless communications network, such as a mobile phone, a tablet computer, a smart home device, a remote medical device, and a driverless automobile.

When mentioned in the embodiments of the disclosure, the “wireless communications network” means a wide area communications network that can be interconnected to another public network or private network, to enable the wireless terminal to transmit and receive information. Communication objects in the wireless communications network include the wireless terminal, one or more access nodes, and a core network device in communication connection with the access node.

When mentioned in the embodiments of the disclosure, the “access node” means a network access device that provides a wireless communication link for the wireless terminal in the wireless communications network, and includes an access network device or a wireless terminal device that supports D2D communication in the wireless communications network. The access node may be an independent physical device, such as a base station, or a mobile phone that supports a D2D function, or may be software installed on a physical device.

When mentioned in the embodiments of the disclosure, a “first access node” means an access node that receives a first connection request sent by the wireless terminal, that is, an access node that is accessed by the wireless terminal when the wireless terminal initiates a connection request for the first time.

When mentioned in the embodiments of the disclosure, an “access node that can be accessed” means an access node that can be locally accessed by the wireless terminal.

When mentioned in the embodiments of the disclosure, a “target access node” means an access node, whose device capability can support a device type and/or a service type of the wireless terminal, that can be locally accessed by the wireless terminal.

When mentioned in the embodiments of the disclosure, a “second access node” means an access node that can be accessed by the wireless terminal other than the first access node, that is, another access node that can be locally accessed by the wireless terminal other than the first access node.

When mentioned in the embodiments of the disclosure, a “core network device” may be a serving GPRS support node (SGSN) or a mobile switching center (MSC) for a 3G network. For a 4th Generation of wireless communication system (4G) network, the core network device may be a mobile management entity (MME). For a 5G network, the core network device may be a core network control device having a function equivalent to that of an MSC or an MME.

When mentioned in the embodiments of the disclosure, a “connection request” means a service request initiated to a core network by the wireless terminal by using an access node, and includes a registration request, a location update request, a user equipment (UE) context update request, a service request, or the like. When mentioned in the embodiments of the disclosure, a “first connection request” and a “second connection request” respectively mean connection requests initiated by the wireless terminal in different phases.

When mentioned in the embodiments of the disclosure, a “connection response” means a response message in response to the foregoing connection request, and includes a registration response, a location update response, a UE context update response, a service request response, or the like. When mentioned in the embodiments of the disclosure, a “first connection response”, a “second connection response”, a “third connection response”, and a “fourth connection response” respectively mean response messages that are sent in response to received connection requests by the core network device in different phases or in different implementation scenarios.

When mentioned in the embodiments of the disclosure, a “device type” means an attribute value that is preset according to a main function of the wireless terminal. A communications device in a 5G system is not limited to a wireless terminal such as a smartphone or a tablet computer. Various communications devices having a wireless communication function, such as a smart home device, a wearable device, a driverless vehicle, and a remote medical machine all access a wireless communications network of the 5G system. Different communications devices are of different device types. Different device types have different requirements on quality of service of the wireless communications network. For example, a device type of machines in a factory that performs mutual communication by using a base station disposed inside or near the factory is machine type device. A device type of a driverless vehicle is vehicle type device. One wireless terminal may correspond to one or more device types. For example, a mobile phone may belong to multiple device types such as communications device and vehicle type device.

When mentioned in the embodiments of the disclosure, a “service type” means an attribute value that is preset according to a wireless network communication quality of service requirement of a service initiated by the wireless terminal. For example, when a driverless vehicle initiates a driverless service, the driverless service has an ultra-low latency requirement on wireless network communication. Therefore, a service type of the driverless service is preset as ultra-low latency service. For another example, for mutual communication performed by machines in a factory by using a base station inside or near the factory, a service type of such a service is preset as local machine type communication service. One wireless terminal may correspond to one or more service types. For example, when a mobile phone initiates a voice communication service, a service type of such a service is voice communication service, and when the mobile phone initiates an in-vehicle navigation service, a service type of such a service is ultra-low latency service.

When mentioned in the embodiments of the disclosure, a “device capability” means a communication type that has different quality of service and that is supported by an access node or an access network served by an access node, and includes ultra-reliable communication, ultra-broadband communication, vehicle-to-everything communication (V2X Communication), D2D Communication, local machine type communication, ultra-low latency communication, or the like. One access node may support one or more device capabilities.

When mentioned in the embodiments of the disclosure, a “radio access bearer” means a connection that is established for the wireless terminal by the access node and that is used for transmitting user data between the wireless terminal and a core network by using the access node. The radio access bearer includes a bearer between the wireless terminal and the access node, and a bearer between the access node and the core network.

When mentioned in the embodiments of the disclosure, a “radio bearer” means a connection that is used for transmitting user data and that is established between the wireless terminal and the access node.

The technical solutions of the disclosure may be applied to various wireless communications systems, for example, a fifth generation wireless communications system, a global system for mobile communications (GSM), a general packet radio service (GPRS) system, a Code Division Multiple Access (CDMA) system, a CDMA2000 system, a Wideband Code Division Multiple Access (WCDMA) system, a Long Term Evolution (LTE) system, or a World Interoperability for Microwave Access (WiMAX) system.

The following describes the technical solutions of the disclosure in detail by using specific embodiments. The following specific embodiments may be mutually combined, and same or similar concepts or processes may not be repeatedly described in some embodiments.

### Embodiment 1

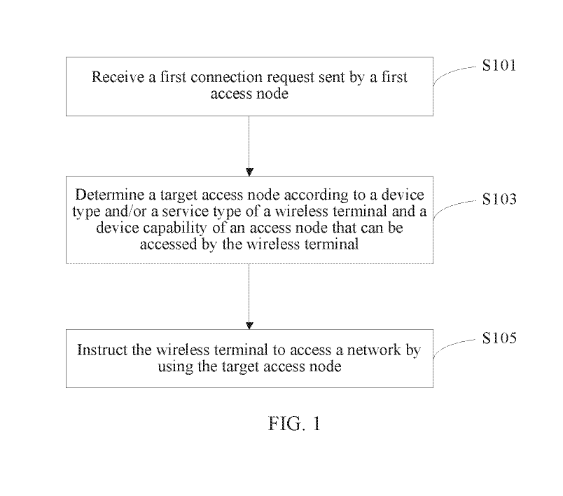

FIG. 1 is a schematic flowchart of a wireless communications access method according to Embodiment 1 of the disclosure. As shown in FIG. 1, the wireless communications access method in this embodiment is performed by a core network device. The method includes the following steps.

S101: Receive a first connection request sent by a first access node.

S103: Determine a target access node according to a device type and/or a service type of the wireless terminal and a device capability of an access node that can be accessed by the wireless terminal.

S105: Instruct the wireless terminal to access a network by using the target access node.

The wireless terminal sends the first connection request to the first access node. The first access node sends the first connection request to the core network device. The first connection request carries the device type and/or the service type of the wireless terminal (that is, at least one of the device type or the service type).

Optionally, after receiving the first connection request sent by the first access node, the core network device authenticates the wireless terminal. The first connection request may further carry an identifier of the wireless terminal. The core network device queries, by using the identifier of the wireless terminal, for user subscription data corresponding to the wireless terminal, determines, according to the subscription data, an authentication manner supported by the wireless terminal, and then authenticates the wireless terminal. Alternatively, the first connection request carries an identifier of the wireless terminal and the device type and/or the service type of the wireless terminal. The core network device determines, according to the device type and/or the service type of the wireless terminal, an authentication manner supported by the wireless terminal, and then authenticates the wireless terminal. Alternatively, the first connection request further carries an authentication manner supported by the wireless terminal and an authentication parameter. The core network device authenticates the wireless terminal according to the authentication manner supported by the terminal and the authentication parameter. After the authentication succeeds, the core network device performs encryption and/or integrity protection for the wireless terminal according to security information supported by the wireless terminal in the subscription data, and establishes a secure connection.

After receiving the first connection request, the core network device determines the access node that can be accessed by the wireless terminal. There is at least one access node that can be accessed by the wireless terminal, that is, the first access node. Alternatively, there may be multiple access nodes that can be accessed, that is, the first access node and one or more second access nodes. The first connection request further carries location information of the wireless terminal. The core network device determines, according to the location information of the wireless terminal, the access node that can be locally accessed by the wireless terminal, and then obtains the device capability of the access node that can be accessed by the wireless terminal. Certainly, the core network device may alternatively determine, in another manner, the access node that can be accessed by the wireless terminal. This is not limited herein.

Optionally, there are multiple methods for obtaining the device capability of the access node by the core network device after determining the access node that can be locally accessed. This is not limited herein. For example, the core network device obtains the device capability from access node device capability information carried in a message sent to the core network device by the access node, or obtains the device capability by querying locally stored access node device capability information, or obtains the device capability from access node device capability information stored on a core network cloud platform, or obtains the device capability from access node device capability information stored in another core network device (for example, a network configuration management device).

The device capability of the access node means a communication type that has different quality of service and that is supported by the access node or an access network served by the access node. Further, the device capability of the access node may further include a core network management capability supported by the access node, for example, a session management function. When the device capability of the access node includes the core network management capability, the core network device may determine, according to the core network management capability supported by the access node, signaling to be delivered to the access node. For example, if the access node supports the session management function, signaling to be sent to the access node by the core network device may carry radio access bearer related information, and may further carry session management related information to be parsed out by the access node, for example, a packet data network (PDN) connection context. If the access node supports in-vehicle communication, signaling to be sent to the access node by the core network device may carry in-vehicle communication session related information to be parsed out by the access node.

One access node may support one or more device capabilities. There are multiple specific representation forms. For example, a device capability status of an access node A is shown in the following table. A bit N represents a device capability, 1 represents “support”, and 0 represents “not support”).

| Bit 6 | Bit 5 | Bit 4 | Bit 3 | Bit 2 | Bit 1 |
|---|---|---|---|---|---|
| 1 | 0 | 0 | 1 | 1 | 0 |

Bit 6: Session Management, 1—support;
Bit 5: Ultra Reliable Communication, 0—not support;
Bit 4: Ultra Broadband Communication, 0—not support;
Bit 3: V2X Communication, 1—support;
Bit 2: D2D Communication, 1—support; and
Bit 1: xx Communication, 0—not support.

It can be learned from the foregoing table that device capabilities of the access node A include session management, V2X communication, and D2D communication.

After obtaining the device capability of the access node, the core network device determines, according to the device type and/or the service type of the wireless terminal and the device capability of the access node that can be accessed by the wireless terminal, an access node whose device capability can support the device type and/or the service type of the wireless terminal, as a target access node from the access node that can be accessed by the wireless terminal. The core network device instructs the wireless terminal to access a wireless communications network by using the target access node.

Further, there are three manners of determining the target access node by the core network device. One of the three manners is selected for use.

1. The core network device determines, according to the device type of the wireless terminal and the device capability of the access node that can be accessed by the wireless terminal, an access node whose device capability can support the device type of the wireless terminal as the target access node from the access node that can be accessed by the wireless terminal.

For example, a device type of a wireless terminal UE₁ is vehicle type device. There are two access nodes that can be accessed by UE₁ such as a base station A and a base station B. A device capability of the base station A is ultra-broadband communication. A device capability of the base station B is V2X Communication. The device capability of the base station B can support the device type of UE₁. Therefore, the core network device determines the base station B as a target access node of UE₁.

2. The core network device determines, according to the service type of the wireless terminal and the device capability of the access node that can be accessed by the wireless terminal, an access node whose device capability can support the service type of the wireless terminal as the target access node from the access node that can be accessed by the wireless terminal.

For example, a wireless terminal UE₁ initiates a navigation service. A service type corresponding to the navigation service is ultra-low latency service. There are two access nodes that can be accessed by the wireless terminal UE₁ such as a base station C and a wireless terminal device UE₂ that supports D2D communication. A device capability of the base station C is ultra-low latency communication. A device capability of UE₂ is ultra-reliable communication. The device capability of the base station C can support a device type of UE₁. Therefore, the core network device determines the base station C as a target access node of UE₁.

3. The core network device determines, according to the device type and the service type of the wireless terminal and the device capability of the access node that can be accessed by the wireless terminal, an access node whose device capability can support the device type and the service type of the wireless terminal as the target access node from the access node that can be accessed by the wireless terminal.

For example, a device type of a wireless terminal UE₁ is machine type device, and a service type of UE₁ is local machine type communication. An access node that can be accessed by UE₁ is a base station D. A device capability of the base station D is local machine type communication. The device capability of the base station D can support the device type and the service type of UE₁. Therefore, the core network device determines the base station D as a target access node of UE₁.

There are multiple methods for determining whether the device capability of the access node supports the device type and/or the service type of the wireless terminal, for example, presetting, in the core network device, a relationship mapping table between the device type and/or the service type of the wireless terminal and the device capability of the access node, and determining, according to the device type and/or the service type of the wireless terminal, the device capability of the access node, and the relationship mapping table, whether the device capability of the access node supports the device type and/or the service type of the wireless terminal; or matching quality of service that is required by the device type and/or the service type of the wireless terminal with quality of service that is supported by the device capability of the access node, and determining whether the device capability of the access node supports the device type and/or the service type of the wireless terminal. A specific determining method is not limited in this embodiment of the disclosure.

It should be noted that when there are multiple access nodes that can be accessed by the wireless terminal, that is, when the first access node and one or more second access nodes are included, the core network device may first determine whether a device capability of the first access node supports the device type and/or the service type of the wireless terminal. If the device capability of the first access node supports the device type and/or the service type of the wireless terminal, the core network device directly determines the first access node as the target access node, and does not determine a second access node. If the device capability of the first access node does not support the device type and/or the service type of the wireless terminal, the core network device determines whether a device capability of a second access node supports the device type and/or the service type of the wireless terminal.

Alternatively, the core network device determines whether all access nodes that can be accessed by the wireless terminal support the device type and/or the service type of the wireless terminal. If there is one access node whose device capability supports the device type and/or the service type of the wireless terminal, the core network device determines the access node as the target access node. If there are multiple access nodes whose device capabilities support the device type and/or the service type of the wireless terminal, the core network device selects any access node as the target access node, or selects, as the target access node, an access node having optimal signal strength or signal quality (where signal quality is a ratio of signal strength to noise strength) when the wireless terminal accesses the access node, or selects an access node that can provide best QoS for the wireless terminal as the target access node, or directly selects the first access node as the target access node (where the device capability of the first access node supports the device type and/or the service type of the wireless terminal). A specific determining method is not limited herein.

In this embodiment of the disclosure, a core network device determines, according to a device type and/or a service type of a wireless terminal and a device capability of an access node that can be accessed by the wireless terminal, an access node whose device capability can support the device type and/or the service type of the wireless terminal as a target access node, and instructs the wireless terminal to access a network by using the target access node. Terminals of different device types or service types access nodes meeting their service requirements, so that better communication quality is provided for wireless terminals.

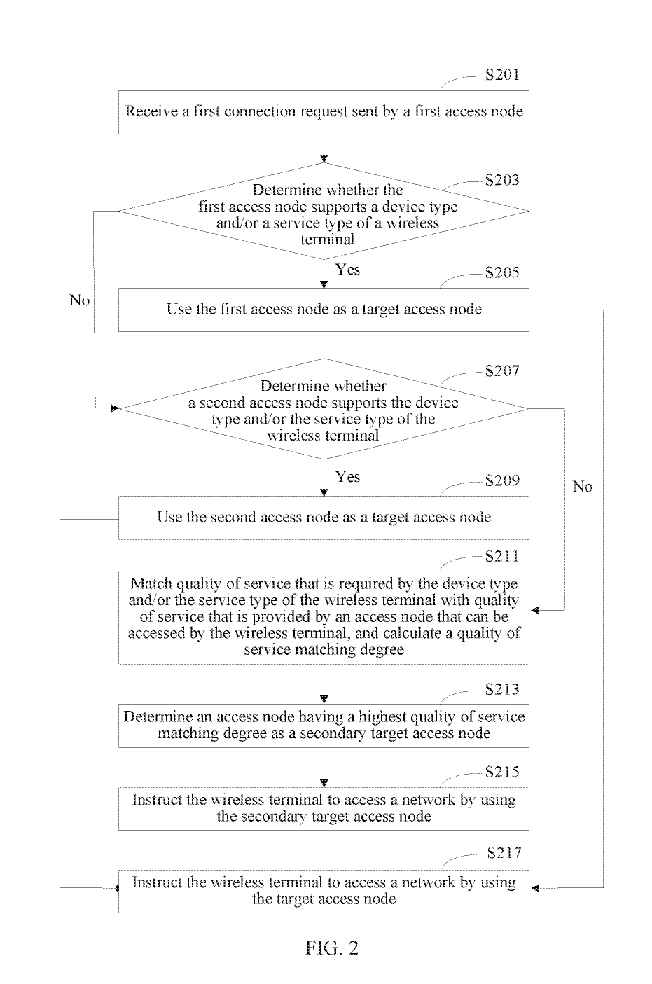

FIG. 2 is a schematic flowchart of another wireless communications access method according to Embodiment 1 of the disclosure. As shown in FIG. 2, the wireless communications access method in this embodiment is performed by a core network device. The method includes the following steps.

S201: Receive a first connection request sent by a first access node.

S203: Determine, according to a device type and/or a service type of the wireless terminal and a device capability of the first access node, whether the device capability of the first access node supports the device type and/or the service type of the wireless terminal.

If the device capability of the first access node supports the device type and/or the service type of the wireless terminal, go to step S205. If the device capability of the first access node does not support the device type and/or the service type of the wireless terminal, go to step S207.

S205: Use the first access node as the target access node, and go to step S217.

S207: Determine, according to the device type and/or the service type of the wireless terminal and a device capability of the second access node, whether the device capability of the second access node supports the device type and/or the service type of the wireless terminal.

If the device capability of the second access node supports the device type and/or the service type of the wireless terminal, go to step S209. If the device capability of the second access node does not support the device type and/or the service type of the wireless terminal, go to step S211.

S209: Use the second access node as the target access node, and go to step S217.

S211: Match QoS that is required by the device type and/or the service type of the wireless terminal with QoS that is provided by the access node that can be accessed by the wireless terminal, and calculate a QoS matching degree.

S213: Determine an access node having a highest QoS matching degree as a secondary target access node, and go to step S215.

S215: Instruct the wireless terminal to access a network by using the secondary target access node.

S217: Instruct the wireless terminal to access a network by using the target access node.

The wireless terminal sends the first connection request to the first access node. The first connection request carries the device type and/or the service type of the wireless terminal. The first access node forwards the first connection request to the core network device. The first access node may add the device capability of the first access node to the first connection request, and send the first connection request to the core network device.

In one aspect, after receiving the first connection request sent by the first access node, the core network device authenticates the wireless terminal. The first connection request may carry an identifier of the wireless terminal. The core network device queries, by using the identifier of the wireless terminal, for user subscription data corresponding to the wireless terminal, determines, according to the subscription data, an authentication manner supported by the wireless terminal, and then authenticates the wireless terminal. Alternatively, the first connection request carries the device type and/or the service type of the wireless terminal. The core network device determines, according to the device type and/or the service type of the wireless terminal, an authentication manner supported by the wireless terminal, and then authenticates the wireless terminal. Alternatively, the first connection request carries an authentication manner supported by the wireless terminal and an authentication parameter. The core network device authenticates the wireless terminal according to the authentication manner supported by the terminal and the authentication parameter. After the authentication succeeds, the core network device performs encryption and/or integrity protection on the wireless terminal, and establishes a secure connection.

In another aspect, after receiving the first connection request sent by the first access node, the core network device obtains the device capability of the first access node. There are multiple specific obtaining methods. For example, the core network device queries a device capability of an access node prestored in a core network server for the device capability of the first access node according to an identifier of the first access node. Alternatively, when the first access node forwards the first connection request sent by the wireless terminal, the first access node adds the device capability of the first access node to the first connection request, and sends the first connection request to the core network device. This embodiment does not limit a specific manner of obtaining the device capability of the first access node by the core network device.

Further, the device capability of the access node includes communication types that have different QoS and that are supported by the access node, and further includes a core network management capability supported by the device capability, for example, a session management function. When the device capability of the access node includes the core network management capability, the core network device may determine, according to the core network management capability supported by the access node, signaling to be delivered to the access node. For example, if the access node supports the session management function, signaling to be sent to the access node by the core network device may carry radio access bearer related information, and may further carry session management related information to be parsed out by the access node, for example, a PDN connection context. If the access node supports in-vehicle communication, signaling to be sent to the access node by the core network device may carry in-vehicle communication session related information to be parsed out by the access node.

The core network device determines, according to the device type and/or the service type of the wireless terminal and the device capability of the first access node, whether the first access node supports the device type and/or the service type of the wireless terminal. There are three specific determining manners such as determining, according to the device type of the wireless terminal and the device capability of the first access node, whether the first access node supports the device type of the wireless terminal, or determining, according to the service type of the wireless terminal and the device capability of the first access node, whether the first access node supports the service type of the wireless terminal, or determining, according to the device type and the service type of the wireless terminal and the device capability of the first access node, whether the first access node supports the device type and the service type of the wireless terminal. A specific manner is similar to the determining manner in the foregoing embodiment, and details are not described herein again.

If the device capability of the first access node supports the device type and/or the service type of the wireless terminal, the first access node is determined as the target access node. That is, the wireless terminal continues to access the first access node, and does not need to change the access node.

If the device capability of the first access node does not support the device type and/or the service type of the wireless terminal, it is further determined whether an access node that can be accessed by the wireless terminal other than the first access node supports the device type and/or the service type of the wireless terminal. That is, it is determined whether the second access node supports the device type and/or the service type of the wireless terminal.

Further, the core network device obtains in advance the device capability of the second access node. A specific manner of obtaining the device capability of the second access node is as follows. The first connection request further carries location information of the wireless terminal. The core network device determines, according to the location information of the wireless terminal, another access node that can be accessed by the wireless terminal, that is, determines the second access node, and then obtains the device capability of the second access node.

There may be one or more second access nodes. When there are multiple second access nodes, it is determined whether a device capability of each second access node supports the device type and/or the service type of the wireless terminal.

There are three manners of determining whether the device capability of the second access node supports the device type and/or the service type of the wireless terminal such as determining, according to the device type of the wireless terminal and the device capability of the second access node, whether the second access node supports the device type of the wireless terminal, or determining, according to the service type of the wireless terminal and the device capability of the second access node, whether the second access node supports the service type of the wireless terminal, or determining, according to the device type and the service type of the wireless terminal and the device capability of the second access node, whether the second access node supports the device type and the service type of the wireless terminal. A specific manner is similar to the determining manner in the foregoing embodiment, and details are not described herein again.

If the second access node supports the device type and/or the service type of the wireless terminal, the second access node is determined as the target access node. The wireless terminal is instructed to access a wireless communications network by using the second access node. In this case, the wireless terminal needs to switch from the first access node to the second access node to access the network.

Further, if there are multiple second access nodes that support the device type and/or the service type of the wireless terminal, there are multiple manners of determining a second access node as the target access node, for example, selecting any second access node as the target access node, or obtaining a measurement report on measurement on the multiple second access nodes by the wireless terminal, and selecting, as the target access node according to the measurement report, a second access node from which the wireless terminal receives a signal having strongest signal strength or best signal quality. A manner of determining the target access node when there are multiple second access nodes that support the device type and/or the service type of the wireless terminal is not limited in this embodiment of the disclosure.

If neither the first access node nor the second access node supports the device type and/or the service type of the wireless terminal, it indicates that there is no access node that supports the device type and/or the service type of the wireless terminal. The device type and/or the service type of the wireless terminal is matched with QoS that is provided by the access node that can be accessed, and an access node having a highest QoS matching degree is determined as a secondary target access node. The wireless terminal is instructed to access the network by using the access node having the highest QoS matching degree. If the access node having the highest QoS matching degree is the first access node, the wireless terminal continues to access the network by using the first access node, and does not need to change the access node. If the access node having the highest QoS matching degree is the second access node, the wireless terminal accesses the network by using the second access node. That is, the wireless terminal needs to switch from the first access node to the second access node to access the network. A performing method for instructing, by the core network device, the wireless terminal to access the wireless network by using the secondary target access node may be the same as the performing method for instructing, by the core network device, the wireless terminal to access the wireless network by using the target access node.

It should be noted that, when the first access node does not support the device type and/or the service type of the wireless terminal, and there is no other access node that can be accessed by the wireless terminal, that is, there is no second access node, it also indicates that there is no access node that supports the device type and/or the service type of the wireless terminal. In this case, the device type and/or the service type of the wireless terminal may be matched with QoS that is provided by the access node that can be accessed, and the access node having the highest QoS matching degree is determined as a secondary target access node for access by the wireless terminal, or the terminal continues to access the network by using the first access node.

In this embodiment of the disclosure, a core network device determines, according to a device type and/or a service type of a wireless terminal and a device capability of an access node that can be accessed by the wireless terminal, an access node whose device capability can support the device type and/or the service type of the wireless terminal as a target access node, and instructs the wireless terminal to access a network by using the target access node. Terminals of different device types or service types access nodes meeting their service requirements, so that better communication quality is provided for wireless terminals.

### Embodiment 2

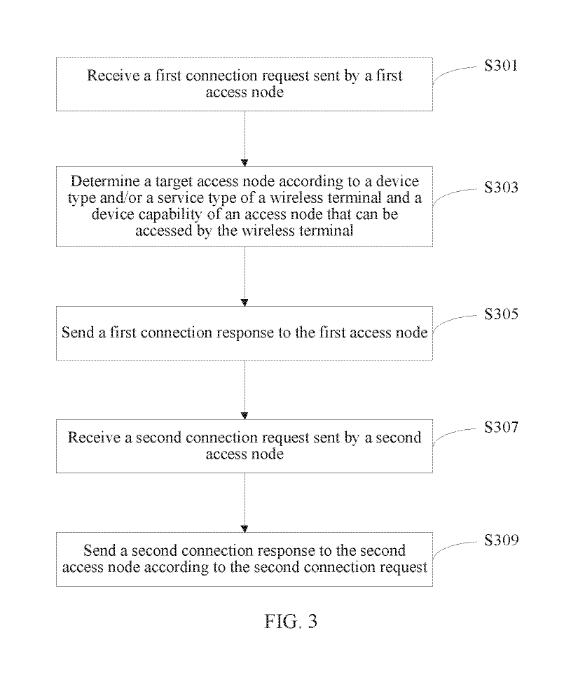

FIG. 3 is a schematic flowchart of another wireless communications access method according to Embodiment 2 of the disclosure. As shown in FIG. 3, the wireless communications access method in this embodiment is performed by a core network device. The method includes the following steps.

S301: Receive a first connection request sent by a first access node.

The first connection request carries a device type and/or a service type of a wireless terminal.

S303: Determine a target access node according to a device type and/or a service type of the wireless terminal and a device capability of an access node that can be accessed by the wireless terminal.

The core network device determines, according to the device type and/or the service type of the wireless terminal and the device capability of the access node that can be accessed by the wireless terminal, a second access node whose device capability can support the device type and/or the service type of the wireless terminal as the target access node. For a process of performing step 301 and step 303, refer to a corresponding method step in the foregoing embodiment. Specific implementation processes are basically the same. Details are not described herein again.

Optionally, after receiving the first connection request sent by the first access node, the core network device authenticates the wireless terminal. The first connection request may carry an identifier of the wireless terminal. The core network device queries, by using the identifier of the wireless terminal, for user subscription data corresponding to the wireless terminal, determines, according to the subscription data, an authentication manner supported by the wireless terminal, and then authenticates the wireless terminal. Alternatively, the first connection request carries the device type and/or the service type of the wireless terminal. The core network device determines, according to the device type and/or the service type of the wireless terminal, an authentication manner supported by the wireless terminal, and then authenticates the wireless terminal. Alternatively, the first connection request carries an authentication manner supported by the wireless terminal and an authentication parameter. The core network device authenticates the wireless terminal according to the authentication manner supported by the terminal and the authentication parameter. After the authentication succeeds, the core network device performs encryption and/or integrity protection for the wireless terminal according to security information supported by the wireless terminal in the subscription data, and establishes a secure connection.

The core network device instructs the wireless terminal to access a wireless communications network by using the second access node. Therefore, the wireless terminal needs to switch from the first access node to the second access node to access the network. The core network device performs the following steps.

S305: Send a first connection response to the first access node.

The first connection response is a response message of the core network device in response to the first connection request, and carries redirection information for instructing the wireless terminal to connect to the second access node.

S307: Receive a second connection request sent by the second access node.

The second connection request is a connection request that is re-initiated by the wireless terminal to the second access node according to the redirection information carried in the first connection response. The second connection request and the first connection request belong to a same connection request transaction. After receiving the second connection request, the second access node forwards the second connection request to the core network device.

S309: Send a second connection response to the second access node according to the second connection request.

The second connection response is a response message of the core network device in response to the second connection request.

After determining, according to the device type and/or the service type of the wireless terminal and the device capability of the access node that can be accessed by the wireless terminal, the second access node as the target access node, the core network device sends, to the first access node, the first connection response that carries the redirection information for instructing the wireless terminal to connect to the second access node. The redirection information includes an identifier of the second access node.

After receiving the first connection response that carries the redirection information, the first access node sends the first connection response to the wireless terminal. Further, the first connection response may further carry an identifier indicating that the first access node rejects the first connection request of the wireless terminal.

After receiving the first connection response, the wireless terminal determines, according to the redirection information carried in the first connection response that the wireless terminal needs to access the network by using the second access node. The wireless terminal sends the second connection request to the second access node according to the redirection information. The second connection request may carry the device type and/or the service type of the wireless terminal. Alternatively, it may be determined, according to the redirection information, that the second access node is a redirected target access node, and it is determined not to add the device type and/or the service type of the wireless terminal to the second access node, to reduce signaling overheads.

The second access node forwards the second connection request to the core network device. Optionally, after receiving the second connection request, the second access node may be set by default in such a manner that a behavior mode of the second access node is the same as that of the first access node. That is, the second access node adds the device capability of the second access node to the second connection request, and sends the second connection request to the core network device.

Further, the wireless terminal may add, to the second connection request, a transaction identifier indicating that the second connection request and the first connection request belong to a same connection transaction. In this way, the second access node determines, according to the transaction identifier, that the second connection request is a redirected terminal connection request, and does not need to add the device capability of the second access node to the second connection request and send the second connection request to the core network device. Alternatively, the core network device determines, according to the transaction identifier, that the second connection request is a redirected terminal connection request, and the core network device does not need to determine again the target access node for the wireless terminal that sends the second connection request. The transaction identifier may be replaced by indication information indicating that the second access node is the target access node, or indication information indicating that the core network device does not need to perform an operation of determining the target access node.

After receiving the second connection request, the core network device respectively performs the following different processing according to different specific transactions in the connection request.

1. When the second connection request is a registration request, after receiving the second connection request, the core network device establishes a bearer for the wireless terminal, and stores a terminal context.

The core network device registers the wireless terminal, and establishes a bearer for the wireless terminal. The bearer is a bearer between interior gateways of a core network (for example, a serving gateway (S-GW) and a packet data network gateway (PDN GW) in a 4G network). The core network device obtains subscription data of the wireless terminal, determines whether there is QoS corresponding to the device type and/or the service type of the wireless terminal in the subscription data, and if there is corresponding QoS, establishes a bearer for the wireless terminal according to the corresponding QoS. If there is no corresponding QoS, the core network device determines QoS according to the device type and/or the service type of the wireless terminal, and then establishes a bearer. Alternatively, the core network device determines QoS directly according to the device type and/or the service type of the wireless terminal, and establishes a bearer. The QoS may be QoS of a non-guaranteed bit rate (Non-GBR), or may be QoS of a guaranteed bit rate (GBR), that is, the bearer may be a GBR bearer or a non-GBR bearer.

2. When the second connection request is a location update request, a terminal context update request, or a service request, the core network device completes location updating, terminal context updating, or a service request of the wireless terminal according to the second connection request. Because the core network device has established a bearer for the wireless terminal, no bearer needs to be reestablished.

The core network device sends a second connection response in response to the second connection request to the second access node. The second connection response is used to indicate that the core network device accepts the second connection request of the wireless terminal. The second connection response respectively carries different information according to different specific transactions in the connection request.

1. When the second connection request is a registration request, the second connection response carries configuration information, determined by the core network device, for establishing a radio access bearer for the wireless terminal by the second access node, so that the second access node establishes a radio access bearer for the wireless terminal according to the configuration information for establishing a radio access bearer for the wireless terminal that is carried in the second connection response.

Alternatively, the second connection response carries only indication information indicating that the core network device accepts the registration request of the wireless terminal, and does not carry the configuration information for establishing a radio access bearer for the wireless terminal. After receiving the second connection response, the second access node notifies the wireless terminal that the registration request of the wireless terminal has been accepted by the core network device, and temporarily, a radio access bearer and a radio bearer that is used for data transmission are not established.

2. When the second connection request is a location update request or a terminal context update request, the second connection response carries information indicating that the core network device accepts the location update request or the terminal context update request, and configuration information, determined by the core network device, for establishing a radio access bearer for the wireless terminal by the second access node, so that the second access node establishes a radio access bearer for the wireless terminal according to the configuration information for establishing a radio access bearer for the wireless terminal that is carried in the second connection response.

Alternatively, the second connection response carries information indicating that the core network device accepts the location update request or the terminal context update request, so that after receiving the second connection response, the second access node notifies the wireless terminal that the location update request or the terminal context update request of the wireless terminal has been accepted by the core network device, and temporarily, a radio access bearer and a radio bearer that is used for data transmission are not established.

3. When the second connection request is a service request, the second connection response carries configuration information, determined by the core network device, for establishing a radio access bearer for the wireless terminal by the second access node, so that the second access node establishes a radio bearer that is used for data transmission and a radio access bearer for the wireless terminal according to the configuration information for establishing a radio access bearer for the wireless terminal that is carried in the second connection response.

In this embodiment of the disclosure, a core network device determines, according to a device type and/or a service type of a wireless terminal and a device capability of an access node that can be accessed by the wireless terminal, an access node whose device capability can support the device type and/or the service type of the wireless terminal as a target access node, and instructs the wireless terminal to access a network by using the target access node. Terminals of different device types or service types access nodes meeting their service requirements, so that better communication quality is provided for wireless terminals.

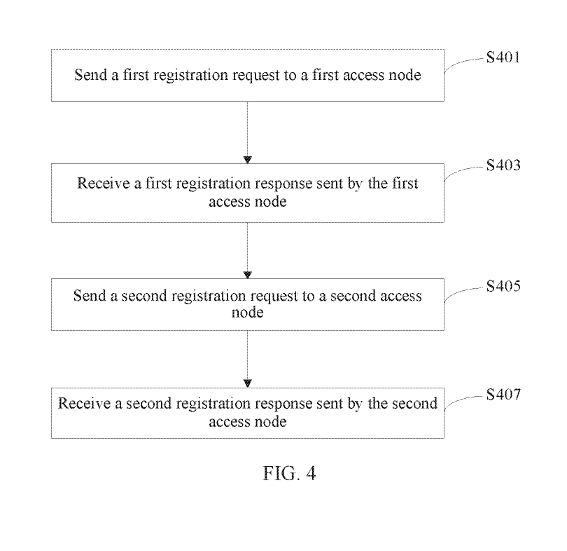

FIG. 4 is a schematic flowchart of another wireless communications access method according to Embodiment 2 of the disclosure. As shown in FIG. 4, the wireless communications access method in this embodiment is performed by a wireless terminal. An application scenario in this embodiment is a registration scenario. The method includes the following steps.

S401: Send a first registration request to a first access node.

The first registration request is a registration request initiated by the wireless terminal to a core network device, and carries at least one of a device type or a service type of the wireless terminal. The first registration request may be an attach request message.

S403: Receive a first registration response that is sent by the first access node and that is in response to the first registration request.

The first registration response is a response message of the core network device in response to the first registration request, and carries registration redirection information for instructing the wireless terminal to connect to a second access node whose device capability can support the device type and/or the service type of the wireless terminal, for registration. The first registration response further includes an identifier of the second access node. The second access node is an access node, whose device capability can support the device type and/or the service type of the wireless terminal that can be accessed by the wireless terminal.

S405: Send a second registration request to the second access node according to the registration redirection information.

The second registration request and the first registration request belong to a same registration transaction. The wireless terminal accesses the second access node according to the redirection information. Optionally, the second registration request carries a transaction identifier indicating that the second registration request and the first registration request belong to a same registration transaction.

S407: Receive a second registration response that is sent by the second access node and that is in response to the second registration request, and complete a registration process.

The second registration response is a response message of the core network device in response to the second registration request.

The second registration response carries configuration information, determined by the core network device, for establishing a radio access bearer for the wireless terminal by the second access node, so that the second access node establishes a radio access bearer for the wireless terminal according to the configuration information, determined by the core network device, for establishing a radio access bearer for the wireless terminal by the second access node that is carried in the second registration response. A radio bearer used for data transmission is established between the wireless terminal and the second access node. A registration process is completed.

Alternatively, the second registration response carries only a terminal identifier and indication information that indicates that the core network device has accepted the registration request of the wireless terminal, and does not carry the configuration information for establishing a radio access bearer for the wireless terminal. After receiving the second registration response, the second access node maintains a signaling connection to the wireless terminal, a registration process is completed, and temporarily, a radio bearer used for data transmission is not established.

Optionally, after establishing the radio bearer between the wireless terminal and the second access node, the wireless terminal further sends, to the first access node, a registration information deletion request for instructing to delete registration information. The first access node deletes registration information of the wireless terminal according to the registration information deletion request.

Optionally, the wireless terminal may not send the registration information deletion request to the first access node. A timer used to calculate a message sending interval of the wireless terminal is preset in the first access node. If the first access node fails to receive, in a preset period of time, any message sent by the wireless terminal, the first access node directly deletes the registration information of the wireless terminal.

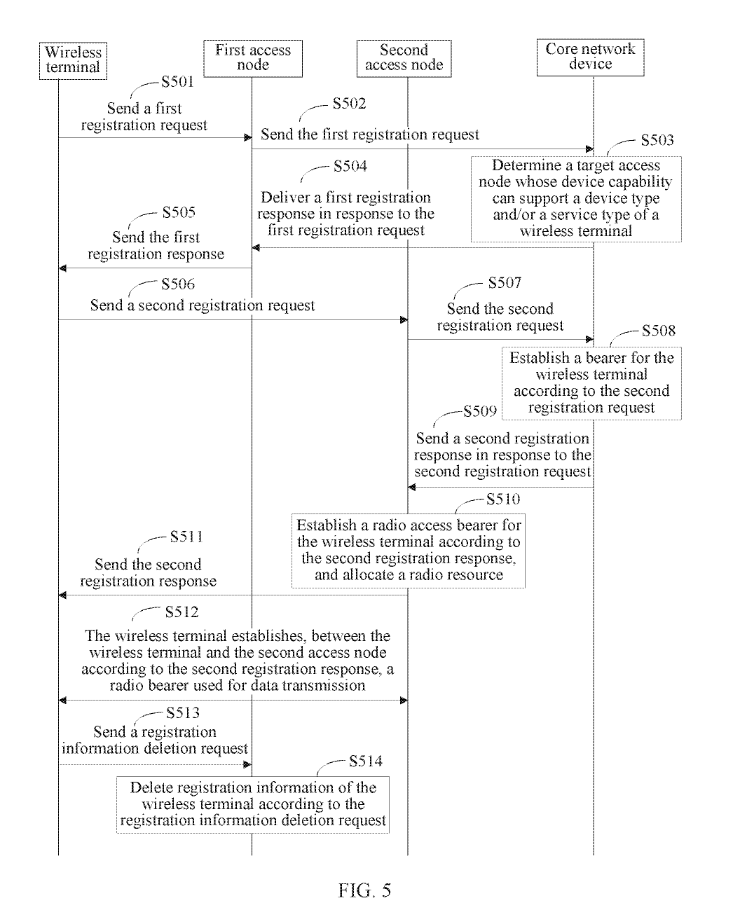

FIG. 5 is a schematic diagram of information exchange between devices in another wireless communications access method according to Embodiment 2 of the disclosure. As shown in FIG. 5, information exchange devices in this embodiment include a wireless terminal, a first access node, a second access node, and a core network device. An application scenario in this embodiment is a registration scenario. The method includes the following steps.

S501: A wireless terminal sends a first registration request to a first access node.

The first registration request is a registration request initiated by the wireless terminal to a core network device, and carries at least one of a device type or a service type of the wireless terminal.

S502: The first access node sends the first registration request to a core network device.

S503: The core network device determines, according to a device type and/or a service type of the wireless terminal and a device capability of an access node that can be accessed by the wireless terminal, a target access node whose device capability can support the device type and/or the service type of the wireless terminal.

The target access node is a second access node. For a process of performing step S503, refer to a corresponding method step in the foregoing embodiment. Specific implementation processes are basically the same. Details are not described herein again.

S504: The core network device delivers a first registration response in response to the first registration request to the first access node.

The first registration response carries registration redirection information for instructing the wireless terminal to connect to the second access node whose device capability can support the device type and/or the service type of the wireless terminal, for registration. The first registration response further includes an identifier of the second access node. The second access node is an access node, whose device capability can support the device type and/or the service type of the wireless terminal that can be accessed by the wireless terminal.

S505: The first access node sends the first registration response to the wireless terminal.

S506: The wireless terminal sends a second registration request to a second access node according to registration redirection information carried in the first registration response.

The second registration request and the first registration request belong to a same registration transaction.

S507: The second access node sends the second registration request to the core network device.

S508: The core network device establishes a bearer for the wireless terminal according to the second registration request.

S509: The core network device sends a second registration response in response to the second registration request to the second access node.

The second registration response may carry configuration information used by the core network device to request the second access node to establish a radio access bearer for the wireless terminal.

S510: The second access node establishes a radio access bearer for the wireless terminal according to the second registration response, and allocates a radio resource.

The second access node establishes a radio access bearer for the wireless terminal according to the configuration information for establishing a radio access bearer for the wireless terminal that is carried in the second registration response, and allocates a radio resource.

S511: The second access node sends the second registration response to the wireless terminal.

The second registration response carries radio resource configuration information of the radio access bearer.

S512: The wireless terminal establishes, between the wireless terminal and the second access node according to the second registration response, a radio bearer used for data transmission.

S513: The wireless terminal sends, to the first access node, a registration information deletion request for instructing to delete registration information.

S514: The first access node deletes registration information of the wireless terminal according to the registration information deletion request.

A wireless terminal sends a first registration request carrying a device type and/or a service type of the wireless terminal to a first access node. The first access node forwards the first registration request to a core network device. Optionally, the first access node adds a device capability of the first access node to the first registration request, and sends the first registration request to the core network device.

The core network device determines, according to a device capability of an access node that can be accessed by the wireless terminal and the device type and/or the service type of the wireless terminal, a target access node whose device capability can support the device type and/or the service type of the wireless terminal. The target access node is a second access node.

The core network device sends a first registration response in response to the first registration request to the first access node. The first registration response carries registration redirection information for instructing the wireless terminal to connect to the second access node for registration. Optionally, the first registration response further includes an identifier of the second access node used as the target access node.

The first access node forwards the first registration response to the wireless terminal. The wireless terminal sends a second registration request to the second access node according to the registration redirection information carried in the first registration response. The second registration request may carry the device type and/or the service type of the wireless terminal. Alternatively, the wireless terminal determines, according to the registration redirection information, that the second access node is an access node whose device capability can support the device type and/or the service type of the wireless terminal. Therefore, the core network device does not need to determine again the access node for the device type and/or the service type. To reduce signaling overheads, the wireless terminal may not add the device type and/or the service type of the wireless terminal to the second registration request.

The second access node forwards the second registration request to the core network device, so that the core network device registers the wireless terminal according to the second registration request, establishes a core network side bearer, and sends a second registration response to the second access node. Optionally, the second registration response carries configuration information, determined by the core network device, for establishing a radio access bearer for the wireless terminal by the second access node.

After the second access node receives the second registration response, if the second registration response carries the configuration information for establishing a radio access bearer for the wireless terminal, the second access node establishes a radio access bearer for the wireless terminal, and allocates a radio resource.

The second access node sends the second registration response to the wireless terminal. The wireless terminal establishes a radio bearer between the wireless terminal and the second access node according to the second registration response. The second access node adds, to the second registration response, radio resource configuration information of the radio access bearer established for the wireless terminal by the second access node. The wireless terminal establishes a radio bearer between the wireless terminal and the second access node according to the radio resource configuration information of the radio access bearer.

Optionally, after establishing the radio bearer between the wireless terminal and the second access node, the wireless terminal sends, to the first access node, a registration information deletion request for instructing to delete registration information. The first access node deletes registration information of the wireless terminal according to the registration information deletion request.

Optionally, the wireless terminal may not send the registration information deletion request to the first access node. A timer used to calculate a message sending interval of the wireless terminal is preset in the first access node. If the first access node fails to receive, in a preset period of time, any message sent by the wireless terminal, the first access node directly deletes the registration information of the wireless terminal.

Further, the second registration request carries a transaction identifier indicating that the second registration request and the first registration request belong to a same registration transaction, so that the second access node determines, according to the transaction identifier, that the second registration request is a redirected terminal registration request, and the core network device determines, according to the transaction identifier, that the second registration request is a redirected terminal registration request. Therefore, the core network device does not need to determine again the target access node for the wireless terminal that sends the second registration request.

In this embodiment of the disclosure, a wireless terminal sends a first registration request to a first access node. The first access node forwards the first registration request to a core network device. The core network device determines, for the wireless terminal, a second access node whose device capability can support a device type and/or a service type of the wireless terminal as a target access node. The wireless terminal re-accesses a wireless communications network according to an indication of the core network device by using the second access node. Terminals of different device types or service types access nodes meeting their service requirements, so that better communication quality is provided for wireless terminals.

### Embodiment 3

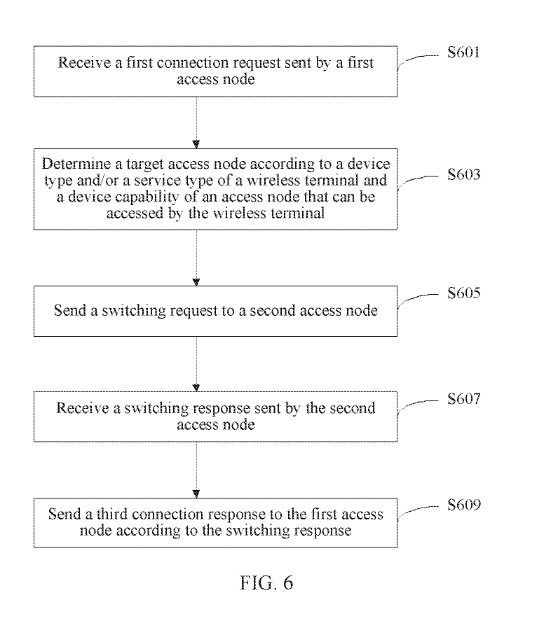

FIG. 6 is a schematic flowchart of another wireless communications access method according to Embodiment 3 of the disclosure. As shown in FIG. 6, the wireless communications access method in this embodiment is performed by a core network device. The method includes the following steps.

S601: Receive a first connection request sent by a first access node.

The first connection request carries a device type and/or a service type of a wireless terminal.

S603: Determine a target access node according to a device type and/or a service type of the wireless terminal and a device capability of an access node that can be accessed by the wireless terminal.

The core network device determines a target access node according to the device type and/or the service type of the wireless terminal and the device capability of the access node that can be accessed by the wireless terminal. The target access node is a second access node whose device capability can support the device type and/or the service type of the wireless terminal. For a process of performing step 601 and step 603, refer to a corresponding method step in the foregoing embodiment. Specific implementation processes are basically the same. Details are not described herein again.

Optionally, after receiving the first connection request sent by the first access node, the core network device authenticates the wireless terminal. The first connection request may carry an identifier of the wireless terminal. The core network device queries, by using the identifier of the wireless terminal, for user subscription data corresponding to the wireless terminal, determines, according to the subscription data, an authentication manner supported by the wireless terminal, and then authenticates the wireless terminal. Alternatively, the first connection request carries the device type and/or the service type of the wireless terminal. The core network device determines, according to the device type and/or the service type of the wireless terminal, an authentication manner supported by the wireless terminal, and then authenticates the wireless terminal. Alternatively, the first connection request carries an authentication manner supported by the wireless terminal and an authentication parameter. The core network device authenticates the wireless terminal according to the authentication manner supported by the terminal and the authentication parameter. After the authentication succeeds, the core network device performs encryption and/or integrity protection for the wireless terminal according to security information supported by the wireless terminal in the subscription data, and establishes a secure connection.

Optionally, after determining the second access node whose device capability can support the device type and/or the service type of the wireless terminal as the target access node, the core network device respectively performs the following different processing according to different specific transactions in the connection request.

1. When the first connection request is a registration request, after receiving the first connection request, the core network device establishes a bearer for the wireless terminal, and stores a terminal context.

The core network device registers the wireless terminal, and establishes a bearer for the wireless terminal. The bearer is a bearer between interior gateways of a core network (for example, an S-GW and a PDN GW in a 4G network). The core network device obtains subscription data of the wireless terminal, determines whether there is QoS corresponding to the device type and/or the service type of the wireless terminal in the subscription data, and if there is corresponding QoS, establishes a bearer for the wireless terminal according to the corresponding QoS. If there is no corresponding QoS, the core network device determines QoS according to the device type and/or the service type of the wireless terminal, and then establishes a bearer. Alternatively, the core network device determines QoS directly according to the device type and/or the service type of the wireless terminal, and establishes a bearer. The QoS may be QoS of a Non-GBR, or may be QoS of a GBR, that is, the bearer may be a GBR bearer or a non-GBR bearer.

2. When the first connection request is a location update request, a terminal context update request, or a service request, because the core network device has established a bearer for the wireless terminal, no bearer needs to be reestablished.

The core network device instructs the wireless terminal to access a wireless communications network by using the second access node. Therefore, the wireless terminal needs to switch from the first access node to the second access node to access the network. The core network device performs the following steps.

S605: Send a handover request to the second access node.

The handover request carries configuration information, determined by the core network device, for establishing a radio access bearer for the wireless terminal by the second access node, so that the second access node establishes a radio access bearer for the wireless terminal according to the radio access bearer configuration information.

Optionally, the handover request further carries terminal context information. The terminal context information includes an identifier of the terminal, the device type and/or the service type of the terminal, a security parameter of the terminal, or the like.

Optionally, the handover request further carries a registration indication for instructing the second access node to accept registration by the wireless terminal. The registration indication is used to indicate, to the second access node, that the handover request is sent for registration.

S607: Receive a handover response sent by the second access node.

The second access node establishes a radio access bearer for the wireless terminal according to the configuration information for establishing a radio access bearer for the wireless terminal that is carried in the handover request, adds radio resource configuration information of the radio access bearer to the handover response, and sends the handover response to the core network device, so that the wireless terminal establishes a radio bearer between the wireless terminal and the second access node according to the radio resource configuration information.

S609: Send a third connection response to the first access node according to the handover response.

The third connection response is a response message of the core network device in response to the first connection request, and carries a handover indication for instructing the wireless terminal to switch to the second access node and the radio resource configuration information of the radio access bearer established for the wireless terminal by the second access node. The first access node forwards the handover response to the wireless terminal. The wireless terminal establishes a radio bearer between the wireless terminal and the second access node according to the handover indication and the radio resource configuration information of the radio access bearer established for the wireless terminal by the second access node.

In this embodiment of the disclosure, a wireless terminal sends a first registration request to a first access node. The first access node forwards the first registration request to a core network device. The core network device determines, for the wireless terminal, a second access node whose device capability can support a device type and/or a service type of the wireless terminal as a target access node. The wireless terminal re-accesses a wireless communications network according to an indication of the core network device by using the second access node. Terminals of different device types or service types access nodes meeting their service requirements, so that better communication quality is provided for wireless terminals.

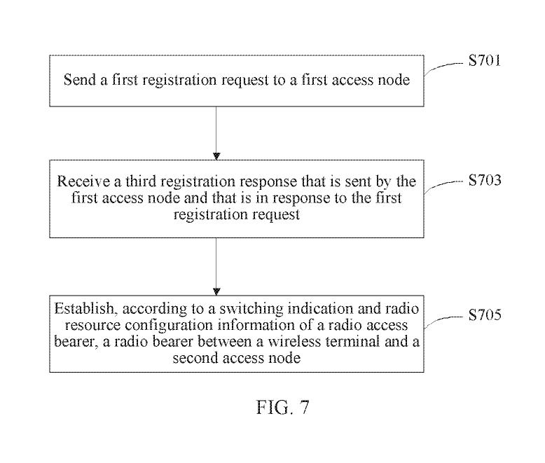

FIG. 7 is a schematic flowchart of another wireless communications access method according to Embodiment 3 of the disclosure. As shown in FIG. 7, the wireless communications access method in this embodiment is performed by a wireless terminal. The method includes the following steps.

S701: Send a first registration request to a first access node. The first registration request carries a device type and/or a service type of the wireless terminal.

S703: Receive a third registration response that is sent by the first access node and that is in response to the first registration request. The third registration response carries a registration handover indication for instructing the wireless terminal to switch to a second access node whose device capability can support the device type and/or the service type of the wireless terminal, and radio resource configuration information of a radio access bearer established for the wireless terminal by the second access node.

S705: Establish, according to the registration handover indication and radio resource configuration information of the radio access bearer, a radio bearer between the wireless terminal and the second access node. A wireless terminal sends a first registration request that carries a device type and/or a service type of the wireless terminal to a first access node. The first access node forwards the first registration request to a core network device. The core network device determines a target access node for the wireless terminal according to the device type and/or the service type of the wireless terminal in the first registration request. The target access node is a second access node whose device capability can support the device type and/or the service type of the wireless terminal.

The first access node receives a third registration response that is delivered by the core network device and that is in response to the first registration request, and forwards the third registration response to the wireless terminal. The third registration response carries a handover indication and radio resource configuration information of a radio access bearer established for the wireless terminal by the second access node.

The wireless terminal establishes, according to the handover indication and the radio resource configuration information of the radio access bearer, a radio bearer between the wireless terminal and the second access node.

Optionally, after establishing the radio bearer between the wireless terminal and the second access node, the wireless terminal sends, to the first access node, a registration information deletion request for instructing to delete registration information. The first access node deletes registration information of the wireless terminal according to the registration information deletion request.

Optionally, the wireless terminal may not send the registration information deletion request to the first access node. A timer used to calculate a message sending interval of the wireless terminal is preset in the first access node. If the first access node fails to receive, in a preset period of time, any message sent by the wireless terminal, the first access node directly deletes the registration information of the wireless terminal.

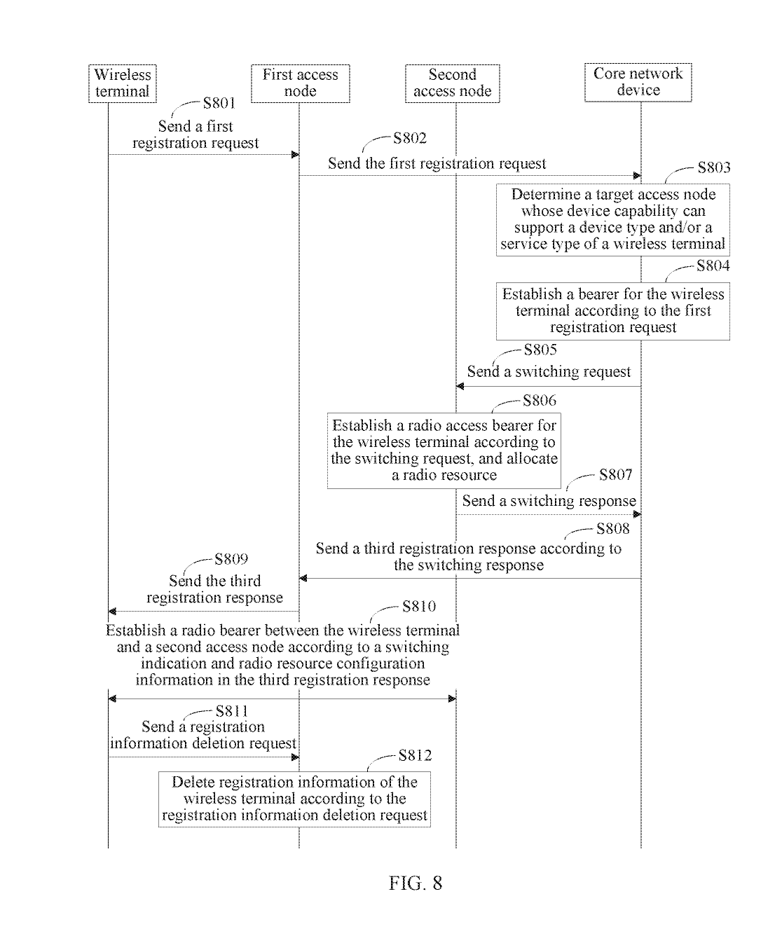

FIG. 8 is a schematic diagram of information exchange between devices in another wireless communications access method according to Embodiment 3 of the disclosure. As shown in FIG. 8, information exchange devices in this embodiment include a wireless terminal, a first access node, a second access node, and a core network device. An application scenario in this embodiment is a registration scenario. The method includes the following steps.

S801: A wireless terminal sends a first registration request to a first access node. The first registration request is a registration request initiated by the wireless terminal to a core network device, and carries at least one of a device type or a service type of the wireless terminal.

S802: The first access node sends the first registration request to a core network device.

S803: The core network device determines, according to a device type and/or a service type of the wireless terminal and a device capability of an access node that can be accessed by the wireless terminal, a target access node whose device capability can support the device type and/or the service type of the wireless terminal. The target access node is a second access node. For a process of performing step S803, refer to a corresponding method step in the foregoing embodiment. Specific implementation processes are basically the same. Details are not described herein again.

S804: The core network device establishes a bearer for the wireless terminal according to the first registration request. The core network device establishes a core network side bearer for the wireless terminal according to the first registration request.

S805: The core network device sends a handover request to a second access node. The handover request carries configuration information for requesting the second access node to establish a radio access bearer for the wireless terminal.

Optionally, the handover request further carries terminal context information. The terminal context information includes an identifier of the terminal, the device type and/or the service type of the terminal, a security parameter of the terminal, or the like.

Optionally, the handover request further carries a registration indication for instructing the second access node to accept registration by the wireless terminal. The registration indication is used to indicate, to the second access node, that the handover request is sent for registration.

S806: The second access node establishes a radio access bearer for the wireless terminal according to the handover request, and allocates a radio resource.

S807: The second access node sends a handover response to the core network device. The handover response carries radio resource configuration information of the radio access bearer that is established for the wireless terminal by the second access node according to the radio access bearer configuration information.

S808: The core network device sends a third registration response to the first access node according to the handover response. The third registration response carries a handover indication for instructing the wireless terminal to switch to the second access node and radio resource configuration information of the radio access bearer established for the wireless terminal by the second access node.

S809: The first access node sends the third registration response to the wireless terminal.

S810: The wireless terminal establishes a radio bearer between the wireless terminal and the second access node according to the handover indication and the radio resource configuration information of the radio access bearer established for the wireless terminal by the second access node in the third registration response.

S811: The wireless terminal sends, to the first access node, a registration information deletion request for instructing to delete registration information.

S812: The first access node deletes registration information of the wireless terminal according to the registration information deletion request. A wireless terminal sends a first registration request to a first access node. The first access node forwards the first registration request to a core network device. The core network device determines a target access node according to a device type and/or a service type of the wireless terminal that is carried in the first registration request and a device capability of an access node that can be accessed by the wireless terminal. The target access node is a second access node. The core network device establishes, according to the device type and/or the service type in the registration request, a core network side bearer that meets QoS that is required by the device type and/or the service type of the wireless terminal, and stores a terminal context.

After determining the second access node as the target access node, the core network device sends a handover request to the second access node, so that the second access node establishes a radio access bearer for the wireless terminal according to configuration information, carried in the handover request, for establishing a radio access bearer for the wireless terminal, and sends a handover response to the core network device.

The core network device obtains, according to the handover response, radio resource configuration information of the radio access bearer established for the wireless terminal by the second access node that is carried in the handover response. The radio resource configuration information of the radio access bearer is added to a third registration response, and sent to the first access node, and is finally sent to the wireless terminal. In this embodiment of the disclosure, a wireless terminal sends a first registration request to a first access node. The first access node forwards the first registration request to a core network device. The core network device determines, for the wireless terminal, a second access node whose device capability can support a device type and/or a service type of the wireless terminal as a target access node. The wireless terminal re-accesses a wireless communications network according to an indication of the core network device by using the second access node. Terminals of different device types or service types access nodes meeting their service requirements, so that better communication quality is provided for wireless terminals.

### Embodiment 4

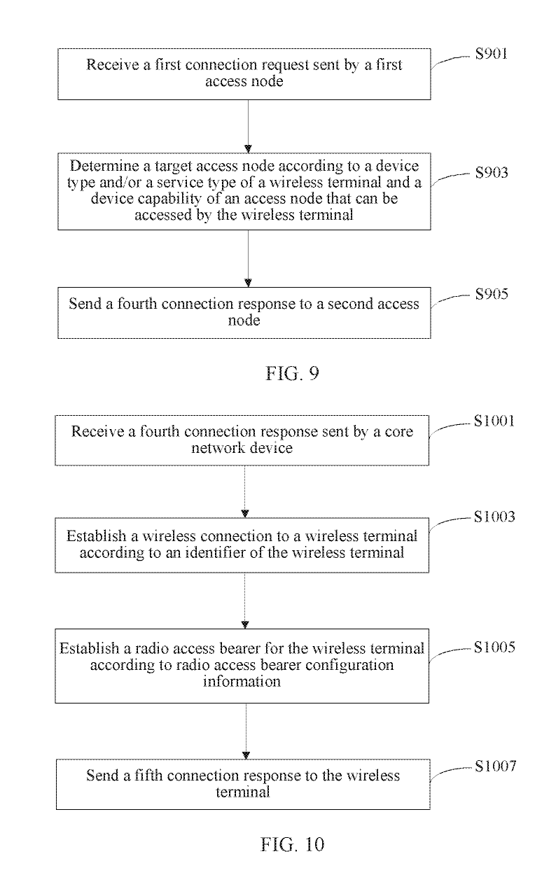

FIG. 9 is a schematic flowchart of another wireless communications access method according to Embodiment 4 of the disclosure. As shown in FIG. 9, the wireless communications access method in this embodiment is performed by a core network device. The method includes the following steps.

S901: Receive a first connection request sent by a first access node. The first connection request carries a device type and/or a service type of a wireless terminal.

S903: Determine a target access node according to a device type and/or a service type of the wireless terminal and a device capability of an access node that can be accessed by the wireless terminal. The core network device determines, according to the device type and/or the service type of the wireless terminal and the device capability of the access node that can be accessed by the wireless terminal, a second access node whose device capability can support the device type and/or the service type of the wireless terminal as the target access node. For a process of performing step 901 and step 903, refer to a corresponding method step in the foregoing embodiment. Specific implementation processes are basically the same. Details are not described herein again.

Optionally, when the first connection request is a registration request, the core network device establishes, according to the device type and/or the service type in the registration request, a core network side bearer that meets QoS that is required by the device type and/or the service type of the wireless terminal, and stores a terminal context. When the first connection request is a location update request, a terminal context update request, or a service request, the core network device completes location updating, terminal context updating, or a service request of the wireless terminal according to a second connection request. Because the core network device has established a bearer for the wireless terminal, no bearer needs to be reestablished.

S905: Send a fourth connection response to the second access node. After determining the second access node whose device capability can support the device type and/or the service type of the wireless terminal as the target access node, the core network device requests the second access node to establish a radio access bearer for the wireless terminal. The fourth connection response carries configuration information for requesting to establish a radio access bearer for the wireless terminal and an identifier of the wireless terminal. The core network device sends the fourth connection response to the second access node. The second access node establishes a radio access bearer for the wireless terminal directly according to the configuration information for establishing a radio access bearer for the wireless terminal and the identifier of the wireless terminal that are carried in the fourth connection response.

Optionally, the fourth connection response further carries terminal context information. The terminal context information includes an identifier of the wireless terminal, the device type and/or the service type of the wireless terminal, a security parameter of the wireless terminal, or the like.

Optionally, the fourth connection response further carries a registration indication for instructing the second access node to accept registration by the wireless terminal. The registration indication is used to indicate, to the second access node, that the response message belongs to a registration transaction.

FIG. 10 is a schematic flowchart of another wireless communications access method according to Embodiment 4 of the disclosure. As shown in FIG. 10, the wireless communications access method in this embodiment is performed by an access node. The method includes the following steps.

S1001: Receive a fourth connection response sent by a core network device. The fourth connection response carries configuration information for establishing a radio access bearer for a wireless terminal and an identifier of the wireless terminal.

Optionally, the fourth connection response further carries terminal context information. The terminal context information includes the identifier of the wireless terminal, a device type and/or a service type of the wireless terminal, a security parameter of the wireless terminal, or the like.

Optionally, the fourth connection response further carries terminal redirection indication. The terminal redirection indication is used to indicate, to the access node, that the wireless terminal is redirected to the access node.

S1003: Establish a wireless connection to the wireless terminal according to an identifier of the wireless terminal.

S1005: Establish a radio access bearer for the wireless terminal according to radio access bearer configuration information.

S1007: Send a fifth connection response to the wireless terminal. The fifth connection response carries radio resource configuration information of the radio access bearer, so that the wireless terminal establishes a radio bearer between the wireless terminal and the access node according to the radio resource configuration information of the radio access bearer.

The access node receives the fourth connection response sent by the core network device, and proactively pages the wireless terminal according to the identifier of the wireless terminal that is carried in the fourth connection response. After detecting a paging request of the access node, the wireless terminal sends a paging response to the access node. In this way, the access node establishes a wireless connection to the wireless terminal. Then, according to the configuration information, delivered by the core network device, for establishing a radio access bearer for the wireless terminal, the access node establishes a radio access bearer for the wireless terminal, and allocates a radio resource. The fifth connection response is sent to the wireless terminal by using the established wireless connection. If the access node has established a wireless connection to the wireless terminal, the access node sends the fifth connection response to the wireless terminal by using the established wireless connection.

Optionally, if the fourth connection response further carries terminal redirection indication, the fifth connection response further carries redirection information for instructing the wireless terminal to connect to the access node, so that the wireless terminal determines, according to the redirection information, that the access node is an access node, whose device capability can support the device type and/or the service type of the wireless terminal, that is determined by the core network device.

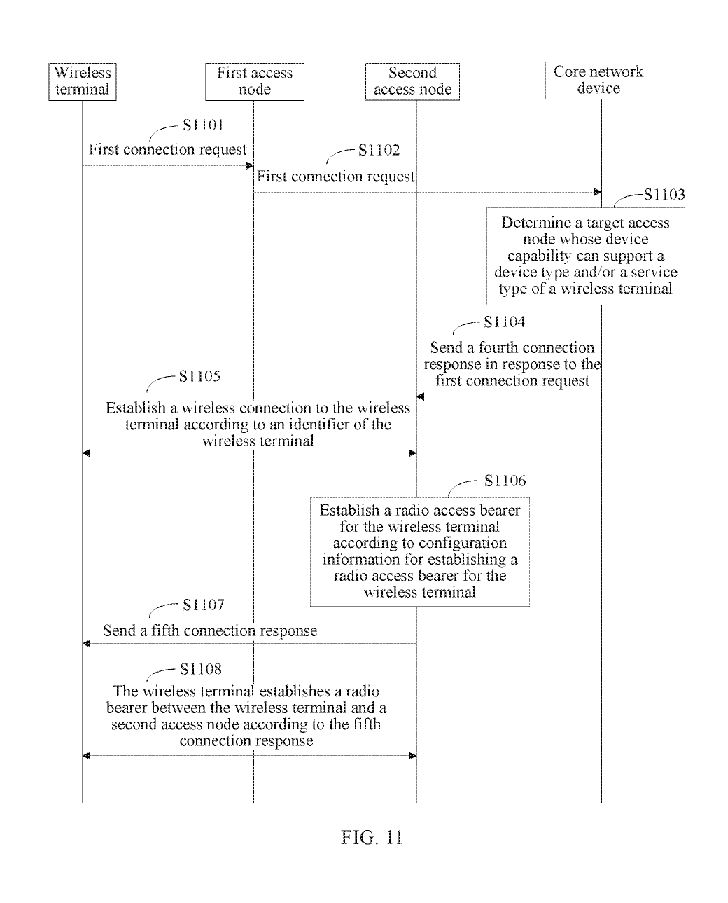

FIG. 11 is a schematic diagram of information exchange between devices in another wireless communications access method according to Embodiment 4 of the disclosure. As shown in FIG. 11, information exchange devices in this embodiment include a wireless terminal, a first access node, a second access node, and a core network device. Application scenarios in this embodiment include a registration scenario, a location update scenario, a UE context update scenario, a service scenario, and the like. The method includes the following steps.

S1101: A wireless terminal sends a first connection request to a first access node.

The first connection request is a connection request initiated by the wireless terminal to a core network device, and carries at least one of a device type or a service type of the wireless terminal.

S1102: The first access node sends the first connection request to a core network device.

S1103: The core network device determines, according to a device type and/or a service type of the wireless terminal and a device capability of an access node that can be accessed by the wireless terminal, a target access node whose device capability can support the device type and/or the service type of the wireless terminal. The target access node is a second access node. For a process of performing step S1103, refer to a corresponding method step in the foregoing embodiment. Specific implementation processes are basically the same. Details are not described herein again.

S1104: The core network device sends a fourth connection response in response to the first connection request to the second access node.

The fourth connection response carries configuration information for establishing a radio access bearer for the wireless terminal and an identifier of the wireless terminal.

S1105: The second access node establishes a wireless connection to the wireless terminal according to the identifier of the wireless terminal.

S1106: The second access node establishes a radio access bearer for the wireless terminal according to configuration information for establishing a radio access bearer for the wireless terminal, and allocates a radio resource.

S1107: The second access node sends a fifth connection response to the wireless terminal.

The fifth connection response carries radio resource configuration information of the radio access bearer.

S1108: The wireless terminal establishes a radio bearer between the wireless terminal and the second access node according to the fifth connection response. A wireless terminal sends a first connection request to a first access node. The first access node forwards the first connection request to a core network device. After determining that a target access node is a second access node whose device capability can support a device type and/or a service type of the wireless terminal, the core network device establishes a core network side bearer for the wireless terminal. The core network device sends a fourth connection response in response to the first connection request to the second access node. After receiving the fourth connection response, according to configuration information for establishing a radio access bearer for the wireless terminal and an identifier of the wireless terminal that are carried in the fourth connection response, the second access node establishes a wireless connection to the wireless terminal, establishes a radio access bearer for the wireless terminal, and allocates a radio resource, and sends a fifth connection response to the wireless terminal by using the established wireless connection. If the second access node has established a wireless connection to the wireless terminal, the second access node sends the fifth connection response to the wireless terminal directly by using the established wireless connection. After receiving radio resource configuration information of the radio access bearer established for the wireless terminal by the second access node, the wireless terminal establishes a radio bearer between the wireless terminal and the second access node according to the information.

In this embodiment of the disclosure, a core network device determines, according to a device type and/or a service type of a wireless terminal and a device capability of an access node that can be accessed by the wireless terminal, an access node whose device capability can support the device type and/or the service type of the wireless terminal as a target access node, and instructs the wireless terminal to access a network by using the target access node. Terminals of different device types or service types access nodes meeting their service requirements, so that better communication quality is provided for wireless terminals.

### Embodiment 5

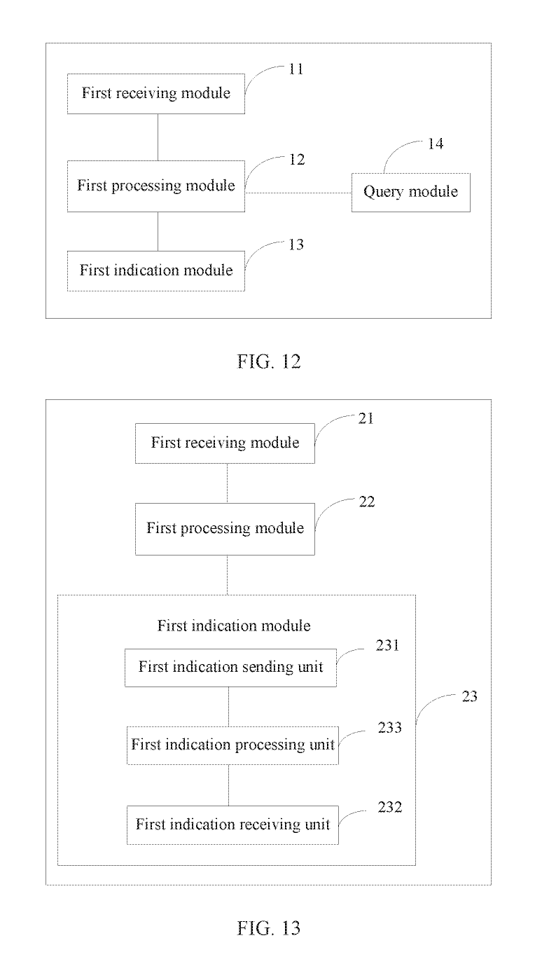

FIG. 12 is a schematic structural diagram of a communications apparatus according to Embodiment 5 of the disclosure. As shown in FIG. 12, the communications apparatus includes a first receiving module 11, a first processing module 12, and a first indication module 13. The first receiving module 11 is in communication connection with the first processing module 12, and sends a first connection request to the first processing module 12. The first processing module 12 is in communication connection with the first indication module 13, and notifies the first indication module 13 of a determining result. The communications apparatus may be disposed in a core network device in networking.

The first receiving module 11 is configured to receive a first connection request sent by a first access node. The first connection request carries a device type and/or a service type of a wireless terminal.

The first processing module 12 is configured to determine, according to the device type and/or the service type of the wireless terminal and a device capability of an access node that can be accessed by the wireless terminal, an access node whose device capability can support the device type and/or the service type of the wireless terminal as a target access node.

The first indication module 13 is configured to instruct the wireless terminal to access a network by using the target access node.

Optionally, the first connection request further carries a device capability of the first access node.

Optionally, the first processing module includes a first judging unit and a first determining unit. The first judging unit is in communication connection with the first determining unit.

The first judging unit is configured to determine, according to the device type and/or the service type of the wireless terminal and the device capability of the first access node, whether the device capability of the first access node supports the device type and/or the service type of the wireless terminal.

The first determining unit is configured to use the first access node as the target access node if the device capability of the first access node supports the device type and/or the service type of the wireless terminal.

Optionally, the first processing module includes a first judging unit, a second judging unit, and a second determining unit. The second judging unit is separately in communication connection with the first judging unit and the second determining unit.

The first judging unit is configured to determine, according to the device type and/or the service type of the wireless terminal and the device capability of the first access node, whether the device capability of the first access node supports the device type and/or the service type of the wireless terminal.

The second judging unit is configured to, if the device capability of the first access node does not support the device type and/or the service type of the wireless terminal, determine, according to the device type and/or the service type of the wireless terminal and a device capability of the second access node, whether the device capability of the second access node supports the device type and/or the service type of the wireless terminal. The second access node is an access node that can be accessed by the wireless terminal other than the first access node.

The second determining unit is configured to use the second access node as the target access node if the device capability of the second access node supports the device type and/or the service type of the wireless terminal.

Optionally, the first connection request further carries location information of the wireless terminal. The apparatus further includes a query module 14. The query module 14 is in communication connection with the first processing module 12.

The query module 14 is configured to determine, by the core network device according to the location information of the wireless terminal, the access node that can be accessed by the wireless terminal, and obtain, by the core network device, the device capability of the access node that can be accessed by the wireless terminal.

Optionally, the first processing module 12 is further configured to, if there is no access node whose device capability supports the device type and/or the service type of the wireless terminal, match, by the core network device, QoS that is required by the device type and/or the service type of the wireless terminal with QoS that is provided by the access node that can be accessed by the wireless terminal, and determine an access node having a highest QoS matching degree as the secondary target access node. The first indication module 13 is further configured to instruct the wireless terminal to access the network by using the secondary target access node.

In this embodiment of the disclosure, a core network device determines, according to a device type and/or a service type of a wireless terminal and a device capability of an access node that can be accessed by the wireless terminal, an access node whose device capability can support the device type and/or the service type of the wireless terminal as a target access node, and instructs the wireless terminal to access a network by using the target access node. Terminals of different device types or service types access nodes meeting their service requirements, so that better communication quality is provided for wireless terminals.

FIG. 13 is a schematic structural diagram of another communications apparatus according to Embodiment 5 of the disclosure. As shown in FIG. 13, the communications apparatus includes a first receiving module 21, a first processing module 22, and a first indication module 23. The first receiving module 21 is in communication connection with the first processing module 22, and sends a first connection request to the first processing module 22. The first processing module 22 is in communication connection with the first indication module 23, and notifies the first indication module 23 of a determining result. The communications apparatus may be disposed in a core network device in networking.

The first receiving module 21 is configured to receive a first connection request sent by a first access node. The first connection request carries a device type and/or a service type of a wireless terminal.

The first processing module 22 is configured to determine, according to the device type and/or the service type of the wireless terminal and a device capability of an access node that can be accessed by the wireless terminal, an access node whose device capability can support the device type and/or the service type of the wireless terminal as a target access node.

The first indication module 23 is configured to instruct the wireless terminal to access a network by using the target access node.

The first indication module 23 includes a first indication sending unit 231, a first indication receiving unit 232, and a first indication processing unit 233. The first indication processing unit 233 is separately in communication connection with the first indication sending unit 231 and the first indication receiving unit 232.

The first indication sending unit 231 is configured to, if the target access node is the second access node that can be accessed by the wireless terminal other than the first access node, send a first connection response in response to the first connection request to the first access node. The first connection response carries redirection information for instructing the wireless terminal to connect to the second access node.

The first indication receiving unit 232 is configured to receive a second connection request sent by the second access node. The second connection request is a connection request that is sent when the wireless terminal connects to the second access node according to the redirection information.

The first indication processing unit 233 is configured to instruct, according to the second connection request, the first indication sending unit 231 to send, to the second access node, a second connection response used to indicate that the core network device accepts the second connection request.

Optionally, the second connection request carries indication information indicating that the second connection request and the first connection request belong to a same connection transaction.

Optionally, the device capability further includes a session management capability supported by the access node.

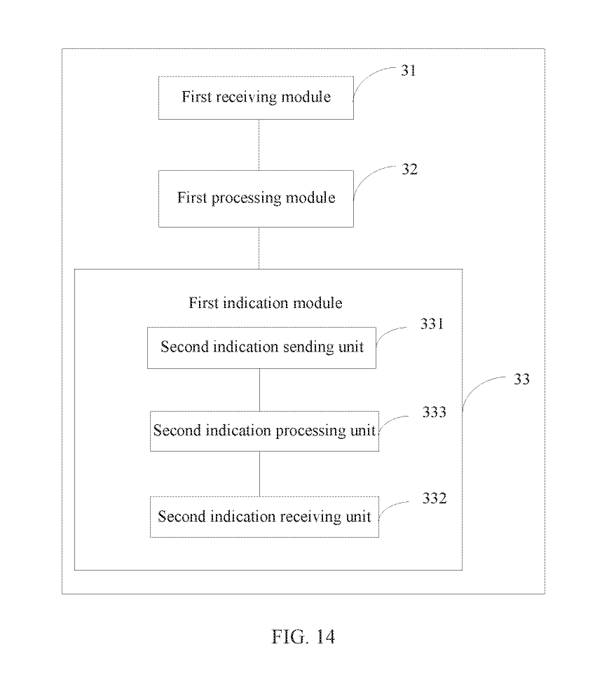

FIG. 14 is a schematic structural diagram of another communications apparatus according to Embodiment 5 of the disclosure. As shown in FIG. 14, the communications apparatus includes a first receiving module 31, a first processing module 32, and a first indication module 33. The first receiving module 31 is in communication connection with the first processing module 32, and sends a first connection request to the first processing module 32. The first processing module 32 is in communication connection with the first indication module 33, and notifies the first indication module 33 of a determining result. The communications apparatus may be disposed in a core network device in networking.

The first receiving module 31 is configured to receive a first connection request sent by a first access node. The first connection request carries a device type and/or a service type of a wireless terminal.

The first processing module 32 is configured to determine, according to the device type and/or the service type of the wireless terminal and a device capability of an access node that can be accessed by the wireless terminal, an access node whose device capability can support the device type and/or the service type of the wireless terminal as a target access node.

The first indication module 33 is configured to instruct the wireless terminal to access a network by using the target access node.

The first indication module 33 includes a second indication sending unit 331, a second indication receiving unit 332, and a second indication processing unit 333. The second indication processing unit 333 is separately in communication connection with the second indication sending unit 331 and the second indication receiving unit 332.

The second indication sending unit 331 is configured to, if the target access node is the second access node that can be accessed by the wireless terminal other than the first access node, send a handover request to the second access node. The handover request carries configuration information for establishing a radio access bearer for the wireless terminal, so that the second access node establishes a radio access bearer for the wireless terminal according to the radio access bearer configuration information.

The second indication receiving unit 332 is configured to receive a handover response sent by the second access node. The handover response carries radio resource configuration information of the radio access bearer, so that the wireless terminal establishes a radio bearer between the wireless terminal and the second access node according to the radio resource configuration information.

The second indication processing unit 333 is configured to instruct, according to the handover response, the second indication sending unit 331 to send a third connection response in response to the first connection request to the first access node. The third connection response carries the radio resource configuration information of the radio access bearer established for the wireless terminal by the second access node and a handover indication for instructing the wireless terminal to switch to the second access node.

Optionally, the device capability further includes a session management capability supported by the access node.

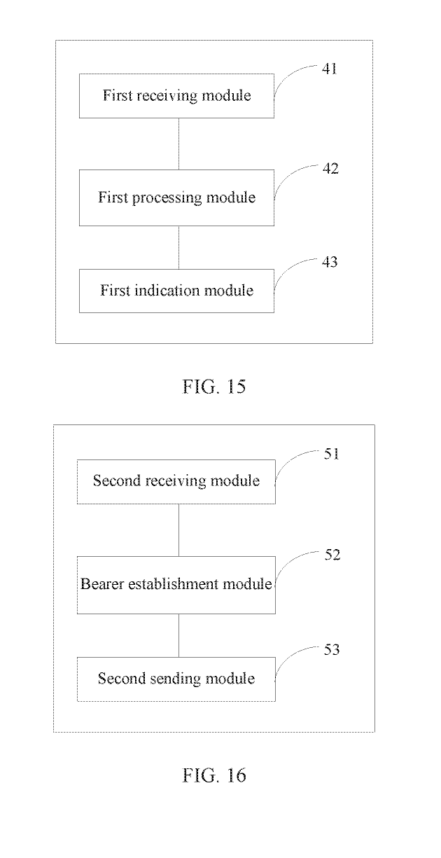

FIG. 15 is a schematic structural diagram of another communications apparatus according to Embodiment 5 of the disclosure. As shown in FIG. 15, the communications apparatus includes a first receiving module 41, a first processing module 42, and a first indication module 43. The first receiving module 41 is in communication connection with the first processing module 42, and sends a first connection request to the first processing module 42. The first processing module 42 is in communication connection with the first indication module 43, and notifies the first indication module 43 of a determining result. The communications apparatus may be disposed in a core network device in networking.

The first receiving module 41 is configured to receive a first connection request sent by a first access node. The first connection request carries a device type and/or a service type of a wireless terminal.

The first processing module 42 is configured to determine, according to the device type and/or the service type of the wireless terminal and a device capability of an access node that can be accessed by the wireless terminal, an access node whose device capability can support the device type and/or the service type of the wireless terminal as a target access node.

The first indication module 43 is configured to, if the target access node is a second access node that can be accessed by the wireless terminal other than the first access node, send a fourth connection response in response to the first connection request to the second access node. The fourth connection response carries configuration information for establishing a radio access bearer for the wireless terminal and an identifier of the wireless terminal.

Optionally, the device capability further includes a session management capability supported by the access node.

In this embodiment of the disclosure, a core network device determines, according to a device type and/or a service type of a wireless terminal and a device capability of an access node that can be accessed by the wireless terminal, an access node whose device capability can support the device type and/or the service type of the wireless terminal as a target access node, and instructs the wireless terminal to access a network by using the target access node. Terminals of different device types or service types access nodes meeting their service requirements, so that better communication quality is provided for wireless terminals.

FIG. 16 is a schematic structural diagram of another communications apparatus according to Embodiment 5 of the disclosure. As shown in FIG. 16, the communications apparatus includes a second receiving module 51, a bearer establishment module 52, and a second sending module 53. The second receiving module 51 is in communication connection with the bearer establishment module 52, and sends a fourth connection response to the bearer establishment module 52. The bearer establishment module 52 is in communication connection with the second sending module 53. The communications apparatus may be disposed in an access node device in networking.

The second receiving module 51 is configured to receive a fourth connection response sent by a core network device. The fourth connection response carries configuration information for establishing a radio access bearer for a wireless terminal and an identifier of the wireless terminal.

The bearer establishment module 52 is configured to establish a wireless connection to the wireless terminal according to the identifier of the wireless terminal, and establish a radio access bearer for the wireless terminal according to the radio access bearer configuration information.

The second sending module 53 is configured to send a fifth connection response to the wireless terminal. The fifth connection response carries radio resource configuration information of the radio access bearer, so that the wireless terminal establishes, between the wireless terminal and the access node according to the radio resource configuration information of the radio access bearer, a radio bearer used for data transmission.

Optionally, the fourth connection response further carries a first indication indicating that the wireless terminal is redirected to the access node.

In this embodiment of the disclosure, a wireless terminal accesses a network by using an access node determined by the core network device as a target access node whose device capability can support a device type and/or a service type of a wireless terminal. In this way, wireless terminals of different device types or service types access nodes meeting their service requirements, so that better communication quality is provided for the wireless terminals.

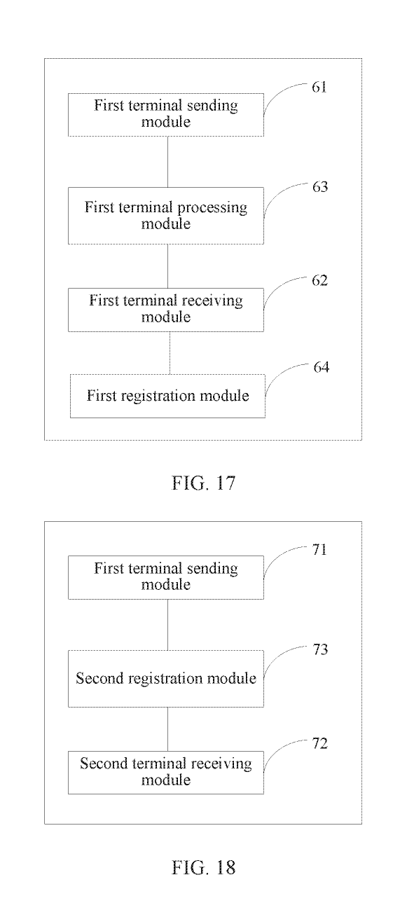

FIG. 17 is a schematic structural diagram of a wireless terminal according to Embodiment 5 of the disclosure. As shown in FIG. 17, the wireless terminal includes a first terminal sending module 61, a first terminal receiving module 62, a first terminal processing module 63, and a first registration module 64. The first terminal processing module 63 is separately in communication connection with the first terminal sending module 61 and the first terminal receiving module 62. The first registration module 64 is in communication connection with the first terminal receiving module 62. The foregoing modules may be integrated into a modem chip of the wireless terminal.

The first terminal sending module 61 is configured to send a first registration request to a first access node. The first registration request carries a device type and/or a service type of the wireless terminal.

The first terminal receiving module 62 is configured to receive a first registration response that is sent by the first access node and that is in response to the first registration request. The first registration response carries registration redirection information for instructing the wireless terminal to connect to a second access node whose device capability can support the device type and/or the service type of the wireless terminal, for registration.

The first terminal processing module 63 is configured to instruct, according to the registration redirection information, the first terminal sending module to send a second registration request to the second access node.

The first terminal receiving module 62 is further configured to receive a second registration response that is sent by the second access node and that is in response to the second registration request.

The first registration module 64 is configured to complete a registration process according to the second registration response.

Optionally, the second registration request carries a transaction identifier indicating that the second registration request and the first registration request belong to a same registration transaction.

Optionally, the first registration module 64 is further configured to establish, between the wireless terminal and the second access node according to the second registration response, a radio bearer used for data transmission, and complete a registration process.

FIG. 18 is a schematic structural diagram of another wireless terminal according to Embodiment 5 of the disclosure. As shown in FIG. 18, the wireless terminal includes a first terminal sending module 71, a second terminal receiving module 72, and a second registration module 73. The second registration module 73 is separately in communication connection with the first terminal sending module 71 and the second terminal receiving module 72.

The first terminal sending module 71 is configured to send a first registration request to a first access node. The first registration request carries a device type and/or a service type of the wireless terminal.

The second terminal receiving module 72 is configured to receive a third registration response that is sent by the first access node and that is in response to the first registration request. The third registration response carries a registration handover indication for instructing the wireless terminal to switch to a second access node whose device capability can support the device type and/or the service type of the wireless terminal, and radio resource configuration information of a radio access bearer established for the wireless terminal by the second access node.

The second registration module 73 is configured to establish, between the wireless terminal and the second access node according to the handover indication and the radio resource configuration information of the radio access bearer, a radio bearer used for data transmission, and complete a registration process.

Optionally, the first terminal sending module 71 is further configured to send a registration information deletion request to the first access node. The registration information deletion request is used to request the first access node to delete registration information of the wireless terminal.

In this embodiment of the disclosure, a core network device determines an access node whose device capability can support a device type and/or a service type of the wireless terminal as a target access node, and the wireless terminal accesses a network by connecting to the target access node. In this way, terminals of different device types or service types access nodes meeting their service requirements, so that better communication quality is provided for wireless terminals.

Embodiment 5 of the disclosure further includes a wireless communications access system. The system includes the communications apparatus according to FIG. 12 to FIG. 15 in Embodiment 5 of the disclosure and the communications apparatus according to FIG. 16 in Embodiment 5 of the disclosure.

Embodiment 5 of the disclosure further includes a communications apparatus. The communications apparatus may be disposed in a core network device in networking. The communications apparatus includes one or more processors, a memory, and one or more programs, where the one or more programs are stored in the memory and are configured to be executed by the one or more processors, and the one or more programs include an instruction used to perform the method shown in FIG. 1, FIG. 2, FIG. 3, FIG. 6, or FIG. 9.

Embodiment 5 of the disclosure further includes a communications apparatus. The communications apparatus may be disposed in an access node in networking. The communications apparatus includes one or more processors, a memory, and one or more programs, where the one or more programs are stored in the memory and are configured to be executed by the one or more processors, and the one or more programs include an instruction used to perform the method shown in FIG. 10.

Embodiment 5 of the disclosure further includes a wireless terminal, including one or more processors, a memory, and one or more programs, where the one or more programs are stored in the memory and are configured to be executed by the one or more processors, and the one or more programs include an instruction used to perform the method shown in FIG. 4 or FIG. 7.

It should be noted that content such as information exchange and an execution process between the units in the device and the system is based on a same idea as the method embodiments of the disclosure. Therefore, for detailed content, refer to descriptions in the method embodiments of the disclosure, and details are not described herein again.

In the several embodiments provided in the disclosure, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of the disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) or a processor to perform a part of the steps of the methods described in the embodiments of the disclosure. The foregoing storage medium includes any medium that can store program code, such as a USB flash drive, a removable hard disk, a read-only memory (ROM), a random access memory (RAM), a magnetic disk, or an optical disc.

It may be understood by a person skilled in the art that, for the purpose of convenient and brief description, division of the foregoing function modules is taken as an example for illustration. In actual application, the foregoing functions can be allocated to different function modules and implemented according to a requirement, that is, an inner structure of an apparatus is divided into different function modules to implement all or part of the functions described above. For a detailed working process of the foregoing apparatus, reference may be made to a corresponding process in the foregoing method embodiments, and details are not described herein again.

Finally, it should be noted that the foregoing embodiments are merely intended for describing the technical solutions of the disclosure, but not for limiting the disclosure. Although the disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the disclosure.

What is claimed is:

1-40. (canceled)

41. A wireless communications access method, wherein the method comprises:
receiving, by a core network device, a first connection request from a first access node, wherein the first connection request comprises at least one of a device type or a service type of a wireless terminal;
determining, by the core network device according to at least one of the device type or the service type of the wireless terminal and a device capability of an access node that is accessible by the wireless terminal, an access node whose device capability supports at least one of the device type or the service type of the wireless terminal as a target access node; and
instructing, by the core network device, the wireless terminal to access a network using the target access node.

42. The wireless communications access method according to claim 41, wherein the first connection request further comprises a device capability of the first access node.

43. The wireless communications access method according to claim 41, wherein determining the access node whose device capability supports at least one of the device type or the service type of the wireless terminal as the target access node comprises:
determining, according to at least one of the device type or the service type of the wireless terminal and the device capability of the first access node, whether the device capability of the first access node supports at least one of the device type or the service type of the wireless terminal; and
using, by the core network device, the first access node as the target access node when the device capability of the first access node supports at least one of the device type or the service type of the wireless terminal.

44. The wireless communications access method according to claim 41, wherein determining the access node whose device capability supports at least one of the device type or the service type of the wireless terminal as the target access node comprises:
determining, by the core network device according to at least one of the device type or the service type of the wireless terminal and the device capability of the first access node, whether the device capability of the first access node supports at least one of the device type or the service type of the wireless terminal;
determining, by the core network device according to at least one of the device type or the service type of the wireless terminal and a device capability of a second access node, whether the device capability of the second access node supports at least one of the device type or the service type of the wireless terminal when the device capability of the first access node does not support at least one of the device type or the service type of the wireless terminal, wherein the second access node is an access node that is accessible by the wireless terminal other than the first access node; and
using, by the core network device, the second access node as the target access node when the device capability of the second access node supports at least one of the device type or the service type of the wireless terminal.

45. The wireless communications access method according to claim 41, wherein the first connection request further comprises location information of the wireless terminal, wherein after receiving the first connection request sent by the first access node, the method further comprises:
determining, by the core network device according to the location information of the wireless terminal, the access node that is accessible by the wireless terminal; and
obtaining, by the core network device, the device capability of the access node that is accessible by the wireless terminal.

46. The wireless communications access method according to claim 41, wherein after determining the access node whose device capability supports at least one of the device type or the service type of the wireless terminal as the target access node, the method further comprises:
matching, by the core network device, quality of service that is required by at least one of the device type or the service type of the wireless terminal with quality of service that is provided by the access node that is accessible by the wireless terminal when there is no access node whose device capability supports at least one of the device type or the service type of the wireless terminal;
determining an access node having a highest quality of service matching degree as a secondary target access node; and
instructing, by the core network device, the wireless terminal to access the network using the secondary target access node.

47. The wireless communications access method according to claim 44, wherein when the target access node is the second access node that is accessible by the wireless terminal other than the first access node, instructing the wireless terminal to access the network using the target access node comprises:
in response to the first connection request, sending, by the core network device, a first connection response to the first access node, wherein the first connection response comprises redirection information for instructing the wireless terminal to connect to the second access node;
receiving, by the core network device, a second connection request from the second access node, wherein the second connection request is received when the wireless terminal connects to the second access node according to the redirection information; and
in response to the second connection request, sending, by the core network device, a second connection response to the second access node according to the second connection request.

48. The wireless communications access method according to claim 47, wherein the second connection request comprises indication information indicating that the second connection request and the first connection request belong to a same connection transaction.

49. The wireless communications access method according to claim 44, wherein when the target access node is the second access node that is accessible by the wireless terminal other than the first access node, instructing the wireless terminal to access the network using the target access node comprises:
sending, by the core network device, a handover request to the second access node, wherein the handover request comprises configuration information for establishing a radio access bearer for the wireless terminal for establishing a radio access bearer for the wireless terminal according to the configuration information for the radio access bearer;
receiving, by the core network device, a handover response from the second access node, wherein the handover response comprises radio resource configuration information of the radio access bearer for the wireless terminal to establish a radio bearer between the wireless terminal and the second access node according to the radio resource configuration information; and
in response to the first connection request, sending, by the core network device, a third connection response to the first access node according to the handover response, wherein the third connection response comprises the radio resource configuration information and a handover indication for instructing the wireless terminal to switch to the second access node.

50. The wireless communications access method according to claim 44, wherein when the target access node is the second access node that is accessible by the wireless terminal other than the first access node, instructing the wireless terminal to access the network using the target access node comprises:
in response to the first connection request, sending, by the core network device, a fourth connection response to the second access node, wherein the fourth connection response comprises configuration information for establishing a radio access bearer for the wireless terminal and an identifier of the wireless terminal.

51. A wireless communications access method, wherein the method comprises:
sending, by a wireless terminal, a first registration request to a first access node, wherein the first registration request comprises at least one of a device type or a service type of the wireless terminal;
in response to the first registration request, receiving, by the wireless terminal, a first registration response from the first access node, wherein the first registration response comprises registration redirection information for instructing the wireless terminal to connect to a second access node whose device capability supports at least one of the device type or the service type of the wireless terminal for registration;
sending, by the wireless terminal, a second registration request to the second access node according to the registration redirection information;
in response to the second registration request, receiving, by the wireless terminal, a second registration response from the second access node; and
completing a registration process according to the second registration response.

52. The wireless communications access method according to claim 51, wherein the second registration request comprises a transaction identifier indicating that the second registration request and the first registration request belong to a same registration transaction.

53. The wireless communications access method according to claim 51, wherein the second registration response comprises radio resource configuration information of a radio access bearer that is established for the wireless terminal by the second access node and wherein receiving the second registration response from the second access node comprises:
establishing, by the wireless terminal between the wireless terminal and the second access node according to the radio resource configuration information of the radio access bearer in the second registration response, a radio bearer used for data transmission; and
completing a registration process.

54. A communications apparatus, comprising:
a memory comprising instructions; and
a processor coupled to the memory, wherein the instructions cause the processor to be configured to:
receive a first connection request from a first access node, wherein the first connection request comprises at least one of a device type or a service type of a wireless terminal;
determine according to at least one of the device type or the service type of the wireless terminal and a device capability of an access node that is accessible by the wireless terminal, an access node whose device capability supports at least one of the device type or the service type of the wireless terminal as a target access node; and
instruct the wireless terminal to access a network using the target access node.

55. The communications apparatus according to claim 54, wherein the first connection request further comprises a device capability of the first access node.

56. The communications apparatus according to claim 54, wherein the instructions further cause the processor to be configured to:
determine according to at least one of the device type or the service type of the wireless terminal and the device capability of the first access node, whether the device capability of the first access node supports at least one of the device type or the service type of the wireless terminal; and
use the first access node as the target access node when the device capability of the first access node supports at least one of the device type or the service type of the wireless terminal.

57. The communications apparatus according to claim 54, wherein the instructions further cause the processor to be configured to:
determine according to at least one of the device type or the service type of the wireless terminal and the device capability of the first access node, whether the device capability of the first access node supports at least one of the device type or the service type of the wireless terminal;
determine according to at least one of the device type or the service type of the wireless terminal and a device capability of a second access node, whether the device capability of the second access node supports at least one of the device type or the service type of the wireless terminal when the device capability of the first access node does not support at least one of the device type or the service type of the wireless terminal, wherein the second access node is an access node that is accessible by the wireless terminal other than the first access node; and
use the second access node as the target access node when the device capability of the second access node supports at least one of the device type or the service type of the wireless terminal.

58. The communications apparatus according to claim 54, wherein the first connection request further comprises location information of the wireless terminal, and wherein the instructions further cause the processor to be configured to:
determine according to the location information of the wireless terminal, the access node that is accessible by the wireless terminal; and
obtain the device capability of the access node that is accessible by the wireless terminal.

59. The communications apparatus according to claim 54, wherein the instructions further cause the processor to be configured to:
match a quality of service that is required by at least one of the device type or the service type of the wireless terminal with a quality of service that is provided by the access node that is accessible by the wireless terminal when there is no access node whose device capability supports at least one of the device type or the service type of the wireless terminal;
determine an access node having a highest quality of service matching degree as a secondary target access node; and
instruct the wireless terminal to access the network using the secondary target access node.

60. The communications apparatus according to claim 57, wherein the instructions further cause the processor to be configured to:
in response to the first connection request, send a first connection response to the first access node, wherein the first connection response comprises redirection information for instructing the wireless terminal to connect to the second access node;
receive a second connection request from the second access node, wherein the second connection request is sent when the wireless terminal connects to the second access node according to the redirection information; and
in response to the second connection request, send a second connection response to the second access node according to the second connection request.
